(19) United States
(12) Patent Application Publication
(10) Pub. No.: US 2015/0019574 A1
(43) Pub. Date: Jan. 15, 2015

(54) OBJECT PLACEMENT DEVICE AND METHOD, AND COMPUTER PROGRAM

(71) Applicant: NEC CORPORATION, TOKYO (JP)

(72) Inventor: Kenichiro Ishikawa, Tokyo (JP)

(73) Assignee: NEC CORPORATION, TOKYO (JP)

(21) Appl. No.: 14/377,880

(22) PCT Filed: Feb. 26, 2013
(86) PCT No.: PCT/JP2013/001089

§ 371 Date: Aug. 11, 2014

(30) Foreign Application Priority Data
Mar. 9, 2012 (JP) 2012-052800

(51) Int. Cl. G06F 17/30

(52) U.S. Cl. CPC G06F 17/30595
USPC 707/752

(57) ABSTRACT

Disclosed is an object placement device and the like that enable to determine an approximate balance in quantity of objects which should be placed in each related placement destination (PD) with a relatively simple processing configuration when a plurality of objects is placed in individual PDs, and the objects that must be moved can be kept to a minimum when PDs increase or decrease. This object placement device 10 includes a function 22 which, on the basis of identification information 11 generated on the basis of information that is specific to an target object to be placed in a PD 14, generates space designation information 15, and a function 24 determines, when the space designation information 15 indicates a specific partial space information included in relational information 12, such that the target object is placed in a PD corresponding to a specific PD identifier associated in the relational information.

### TECHNICAL FIELD

The present invention relates to a technical field which places objects such as data and articles optimally in a specific placement destination.

### BACKGROUND ART

The technology is proposed that, when recording (storing) data as objects to be stored (hereinafter, referred to as “object data”) in a plurality of storages, the object data is stored in the each storage where the object data are nearly evenly (uniformly) distributed. According to such technology, by performing simultaneous access to the plurality of storage, an access performance to the object data can be improved. However, when accessing the object data distributionally recorded in the plurality of storages, it is a problem that a method to examine a state of the storages recording the object data.

As methods to examine the state of the storages recording the object data, the following two methods are considered.

The first method is the method to examine the storages recording the object data by holding a corresponding relationship between the object data and the storage in a table, and referring to the table during data access.

In the second method, first, a corresponding relationship between the object data and the storage is determined by using a specified algorithm based on information specific to the object data (hereinafter, referred to as “metadata”). And in the second method, during data access, by inputting the metadata to the algorithm, a storage which records target object data is examined.

In the first method (method using a table reference) mentioned above, all equipment having a possibility that corresponding relationship between the object data and the storage is examined has to store the table which holds the corresponding relationship therebetween.

On the other hand, the second method (method using algorithm) mentioned above determines the storage which should record the object data by executing the algorithm by an information processing device. Therefore, it is not necessary to store a table holding a correspondence relationship between the object data and the storage in the second method. However, in the second method, the algorithm for recording the object data in the each storage is needed in state of sufficient distribution thereof so that performance improvement of simultaneous access to a plurality of the storages may be demonstrated sufficiently during data access. In the second method, when number of the storages may increase or decrease, it needs the algorithm which calculates correspondence of the object data and the storage corresponding to the fluctuation of the number of the storages. As a related art which discloses the second method, there are patent literature 1 and patent literature 2.

When recording (storing) the object data in a plurality of the storages, management of a correspondence relationship (relational state) between the object data and the storage which stored the object data is a problem. In order to read and write the object data at high speed to the storage, it is necessary to determine a specified storage in which target object data is stored at high speed. The method which determines the correspondence relationship between the object data and the specified storage in which the object data is stored by using the algorithm has high scalability. Therefore, the second method is excellent compared with the first method (method using a table reference) mentioned above.

However, when applying the second method (method using algorithm) mentioned above, quantity (amount of numbers) of object data which move between a plurality of the storages becomes a problem when the storages increase or decrease. Because, when the storages increase or decrease and there is much object data to be moving objects, processing performance may be lowered.

Accordingly, in recent years, a technology is proposed in which, when storages increase or decrease, a state capable of maintaining, by minimum movement of the object data, a state capable of determining a correspondence relationship between the object data and the storage with an algorithm. According to such technology, the storage can be added or deleted easily. However, in such technology, it is required that adjusting flexibly a balance (hereinafter, it may be called a “ratio” or “a degree of distribution”) of quantity of the object data which the each storage stores.

Accordingly, in the second method mentioned above, a technology is proposed. In the technology, a state capable of determining a correspondence relationship between the object data and the storage with an algorithm by the minimum movement of the object data when storages increase or decrease can be maintained. Also, in the technology, a balance of the quantity of the object data the each storage stores can be adjusted appropriately. As such technology, a method disclosed in a non-patent literature 1 and a patent literature 3 are proposed.

FIG. 20 is a diagram explaining a related art disclosed in non-patent literature 1 which exists before the present application was filed. As an example of a system to determine a correspondence relationship between known object data and a storage based on metadata about the object data, a system 600 is shown in FIG. 20. The system 600 determines the storage which records the object data by using the metadata.

That is, in the system 600, by performing a hash operation based on a metadata (object data metadata) 612 among object data and metadata thereof and metadata (storage metadata) 614 among storages and metadata thereof to each storage 610, a hash calculation function 601 obtains a hash 615.

The object data metadata 612 is an identifier which was given in order to specify the object data, and is information such as an address, an object name, a directory name, or a file name. The storage metadata 614 is an identifier which was given in order to specify the storage, and is information which specifies a device or virtual medium, such as an address, a name on a communication network, a device name, or a device number.

Next, a weighting function 602 gets weighted hash 618 by multiplying a hash 615 of each storage 610, and weight information of the storage set up based on the quantity of object data which the each storage 610 can store.

And a maximum hash determination function 603 determines a maximum hash 619 with a biggest value in the weighted hashes 618 for which were obtained about the each storage 610. Finally, a storage corresponding determination function 604 determines the specific storage 610 corresponding to the maximum hash 619, and outputs storage identification information 620 about the storage 610 corresponding to the maximum hash 619.

According to the related art mentioned above, the approximate balances (ratio) in quantity of the object data to be stored in the each storage 610 can be changed by changing the weight information of the storage. According to the related art, when the storage 610 increases or decreases, the state where a correspondence relationship between the object data and the storage 610 is obtained by an algorithm can be maintained by the minimum movement of the object data.

As a related art which exists before the present application was filed, there is a non-patent literature 2, for example. When storages increase or decrease from the state where object data were distributionally placed in a plurality of the storages, an art which can maintain the state where the correspondence relationship between the object data and the storage can be determined with an algorithm by minimum movement of the object data is proposed in the non-patent literature 2. The approximate balance in the quantity of the object data stored in each of the storage can be determined also in the non-patent literature 2.

As a related art which exists before the present application was filed, processing of obtaining a random number value (pseudo-random number value) by using a file name as a seed, and searching a map by using the random number value as a key is described in the patent literature 3. A random number value and a server are associated with the map. The patent literature 3 discloses a technology which selects, with referring to the map, a specific server from a server pool including a plurality of servers by repeating a search, by using the newly calculated random number value, until a server corresponding to a target random number value is found.

### CITATION LIST

### Patent Literature

[PTL 1] Japanese Patent Application Laid-Open No. 2003-216474
[PTL 2] Japanese Patent Application Laid-Open No. 2008-181358
[PTL 3] US2009/0165017A1

### Non-Patent Document: Non Patent Literature

[NPL 1] “CRUSH: controlled, scalable, decentralized placement of replicated data”, Sage A. Weil, Scott A. Brandt, Ethan L. Miller, Carlos Maltzahn, 2006
[NPL 2] “Consistent hashing and random trees: distributed caching protocols for relieving hot spots on the World Wide Web”, David Karger, Eric Lehman, Tom Leighton, Matthew Levine, Daniel Lewin, Rina Panigrahy, 1997

### SUMMARY OF INVENTION

### Technical Problem

However, the method disclosed in the non-patent literature 1 needs to adjust weight information of the storage which determines a balance (ratio) in the numbers of the object which the each storage 610 stores in accordance with the fluctuation of the storage. That is, in the method disclosed in non-patent literature 1, it is necessary to set up a weight of the storage based on the ratio of the quantity of the object stored in the each placement destination whenever placement destinations of the objects increase or decrease. Therefore, according to that method, the processing configuration becomes complicated.

And in the methods disclosed in the patent literatures 1 and 2 and the non-patent literature 2 mentioned above, the balance (the ratio and the dispersion) in the quantity of the object which should be stored between respective placement destinations cannot be determined in detail. There is a problem in the compatibility of the scalability and the efficiency in the method disclosed in the patent literature 3.

Accordingly, a main object of the present invention is to provide an object placement device capable of determining an approximate balance in the quantity of the objects which should be placed in each related placement destination with a relatively simple processing configuration when a plurality of objects is placed in individual placement destinations, and the objects that must be moved can be kept to a minimum when placement destinations increase or decrease.

### Solution to Problem

In order to achieve the above-mentioned object, an object placement device according to the present invention is characterized by including the following configuration.

That is, the object placement device includes:

space designation information generation means for generating space designation information, which indicates a multi-dimensional space allocated a partial space composing a part of a space which a self-device treats and have almost no correspondence relationship when mutually different identifier information are assigned, based on the identifier information generated on the basis of information specific to a target object to be placed in a placement destination; and

placement destination determination means for referring to relational information, which is associated with a placement destination identifier identifying the each placement destination capable of being placed an object and partial space information indicating the partial space, based on the space designation information, and for determining, when being determined that the space designation information indicates partial space information included in the relational information, that the target object is placed in a placement destination corresponding to a specific placement destination identifier associated with the indicated specific partial space information in the relational information.

In another aspect of the present invention, an object placement method according to the present invention is characterized by including the following configuration.

That is, the object placement method includes:

generating space designation information, which indicates a multi-dimensional space allocated a partial space composing a part of a space which a self-device treats and have almost no correspondence relationship when mutually different identifier information are assigned, based on the identifier information generated on the basis of information specific to a target object to be placed in a placement destination;

referring to relational information, which is associated with a placement destination identifier identifying the each placement destination capable of being placed an object and partial space information indicating the partial space, based on the space designation information; and

determining, when being determined that the space designation information indicates partial space information included in the relational information, that the target object is placed in a placement destination corresponding to a specific placement destination identifier associated with the indicated specific partial space information in the relational information.

The same object is also achieved by a computer program and a computer-readable storage media storing the computer program which realizes the object placement device or the object placement method including aforementioned configuration.

### Advantageous Effects of Invention

According to the present invention, an approximate balance in the quantity of objects which should be placed in each related placement destination can be determined with a relatively simple processing configuration when a plurality of objects are placed in individual placement destinations, and the objects that must be moved can be kept to a minimum when placement destinations increase or decrease.

### BRIEF DESCRIPTION OF DRAWINGS

FIG. 1 is a block diagram showing a configuration of an object placement device according to an exemplary embodiment of the present invention.

FIG. 2 is a block diagram showing a configuration of an object data placement device in a first exemplary embodiment of the present invention.

FIG. 3A is a chart exemplifying a partial space-storage relational table according to the first exemplary embodiment of the present invention.

FIG. 3B is a chart exemplifying a partial space-storage relational table according to the first exemplary embodiment of the present invention.

FIG. 4 is a chart explaining a placement operation of object data by the object data placement device according to the first exemplary embodiment of the present invention.

FIG. 5 is a chart explaining an operation when adding a storage from the placement state shown in FIG. 4 by the object data placement device according to the first exemplary embodiment of the present invention.

FIG. 6 is a chart explaining an operation when reducing a storage from the placement state shown in FIG. 4 by the object data placement device according to the first exemplary embodiment of the present invention.

FIG. 7 is a flow chart showing placement processing of object data which the object data placement device according to the first exemplary embodiment of the present invention performs.

FIG. 8 is a diagram explaining a case where the object data placement device according to the first exemplary embodiment of the present invention is applied to a two-dimensional space exemplarily.

FIG. 9A is a diagram explaining a case where the object data placement device according to the first exemplary embodiment of the present invention is applied to a three-dimensional space exemplarily.

FIG. 9B is a diagram explaining a case where the object data placement device according to the first exemplary embodiment of the present invention is applied to a three-dimensional space exemplarily.

FIG. 10 is a block diagram showing a configuration of an object data placement device in a second exemplary embodiment of the present invention.

FIG. 11 is a flow chart showing placement processing of object data which the object data placement device according to the second exemplary embodiment of the present invention performs.

FIG. 12 is a diagram explaining operations of three space designation information calculation functions according to a modification of the second exemplary embodiment.

FIG. 13 is a block diagram showing a configuration of an object destination determination device according to a third exemplary embodiment of the present invention.

FIG. 14 is a flow chart showing destination determination processing of an object which the object destination determination device according to the third exemplary embodiment of the present invention performs.

FIG. 15 is a block diagram showing a configuration of a storage destination determination system of a stock according to the third exemplary embodiment of the present invention.

FIG. 16A is a chart explaining a variation of a system environment according to a fourth exemplary embodiment of the present invention exemplarily.

FIG. 16B is a chart explaining a variation of a system environment according to the fourth exemplary embodiment of the present invention exemplarily.

FIG. 17 is a diagram explaining a hardware configuration of a client or a storage according the first to the fourth exemplary embodiment, and a modification thereof exemplarily.

FIG. 18 is a diagram showing a configuration of a storage system as an example according to the second exemplary embodiment of the present invention.

FIG. 19 is a chart showing a relational table of a partial space and a storage node in the storage system as the example according to the second exemplary embodiment of the present invention.

FIG. 20 is a diagram explaining related art disclosed in the non-patent literature 1 which exists before the present application was filed.

### DESCRIPTION OF EMBODIMENTS

Next, an exemplary embodiment of the present invention is described in detail with reference to drawings. The exemplary embodiment described below does not limit the present invention relating to the scope of claims, and not all of combination of configurations described in the exemplary embodiment may be necessarily indispensable for a solution function of the present invention.

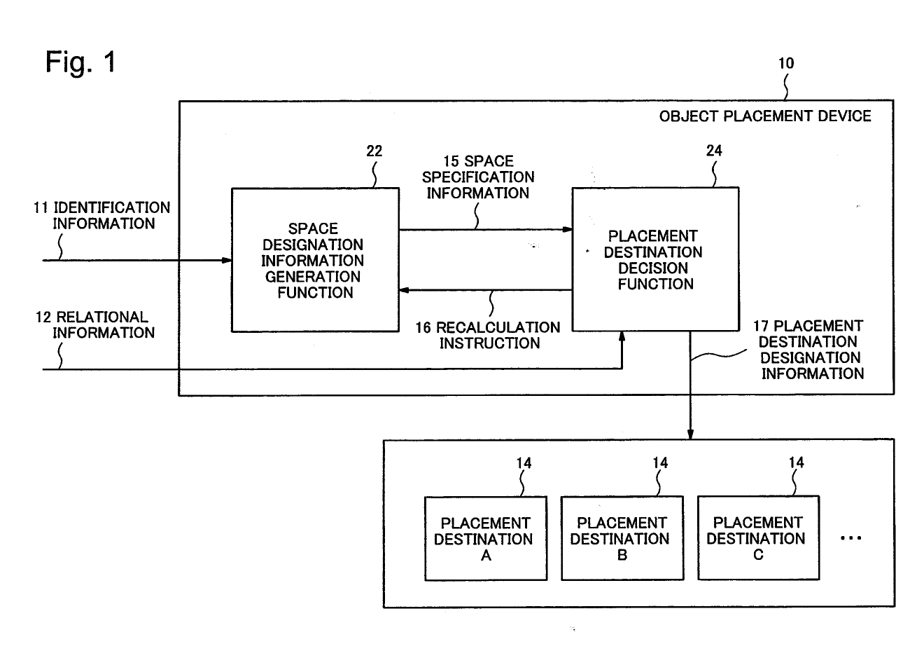

FIG. 1 is a block diagram showing a configuration of an object placement device according to an exemplary embodiment of the present invention and represents a concept common to each exemplary embodiment, and the modification thereof, and an example described below.

In FIG. 1, the object placement device 10 is a device which determines placement destinations of a plurality of objects (not shown) from a plurality of placement destinations (A, B, C, . . . n) 14. This object placement device 10 has a space designation information generation function 22 and a placement destination determination function 24. The object placement device 10 can refer to identifier information 11 and relational information 12. The identifier information 11 is information (metadata, for example) generated based on specific information which an object has individually. The relational information 12 is described later.

The space designation information generation function 22, by using the identifier information 11, generates space designation information 15 that have almost no correspondence relationship when it was generated based on mutually different identifier information. Here, it is supplemented about a relation of “have almost no correspondence relationship when it was generated based on mutually different identifier information” in the space designation information 15. This relation, for example, when assuming that space designation information B are generated in sequence based on identifier information B while space designation information A are generated in sequence based on identifier information A, is a relation that the generated space designation information A group and the generated space designation information B group have almost no correspondence relationship.

The placement destination determination function 24 determines a placement destination of a target object by using relational information 12 and space designation information 15 generated by the space designation information generation function 22.

The relational information 12 is information with which a placement destination identifier AID and a partial space PS are associated in advance. This placement destination identifier AID is information (for example, an identifier representing a specific storage) with which a placement destination 14 can be distinguished (specified).

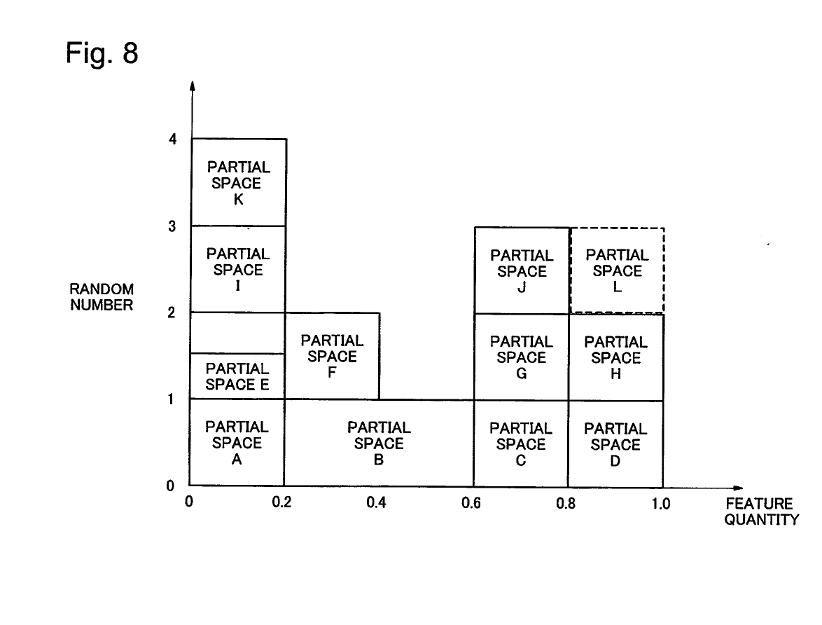

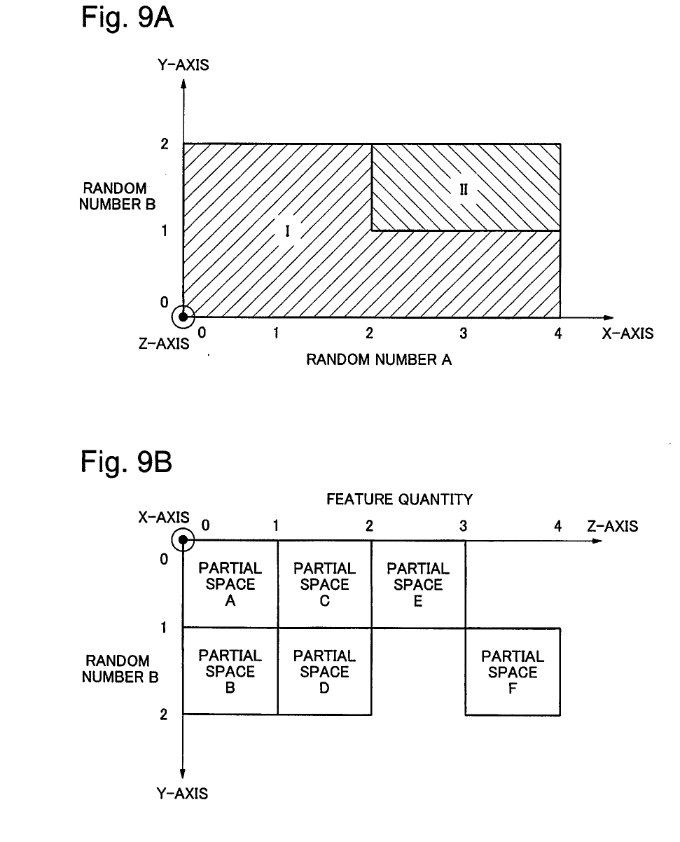

The partial space PS and the space designation information 15 are explained hereinafter. In the present exemplary embodiment, all partial spaces PS are included in a space (whole space) WS. For the space WS, various spaces, such as a one-dimensional space (straight line), a two-dimensional space (for example, FIG. 8 mentioned later), a three-dimensional space (for example, FIG. 9A and FIG. 9B mentioned later) and a multi-dimensional space are adoptable. However, when a multi-dimensional space is adopted as the space WS, various advantages are enjoyable, compared with a case where a one-dimensional space is adopted, when implementing.

As the space WS, various spaces such as a continuous space, a discontinuous space, an Euclidean space, and a non-Euclidean space are adoptable. As a simple example, when assuming a coordinate axis that forms a number line to be a one-dimensional space, the coordinate axis that forms the number line is an example of the space WS. And a value of an integer on the number line or each line segment representing a numerical value range discontinuously allocated on the number line represents a partial space PS.

As a different example of the space WS, when it is a two-dimensional space, an Euclidean space which is continuous is adoptable. In case of the two-dimensional space, for example, the space WS represents a point specified by real values set up on two coordinate axes, respectively which compose the two-dimensional space, or a rectangular area divided by respective line segments representing numerical value ranges allocated discontinuously on the two coordinate axes represents a partial space. And the space designation information 15 is information to be used for specifying a partial space (partial space area) PS included (allocated) in such various dimensional spaces (whole space area) WS.

Because each partial space PS allocated in the space area can be specified by the space designation information 15 as mentioned above, and is associated with a placement destination identifier AID, the placement destination 14 corresponding to the placement destination identifier AID can be specified. And a size of the each partial space PS is different in the size which occupies in the space WS in accordance with a quantity (number) of objects which can be placed in the corresponding placement destination 14. The difference in this size corresponds to a balance (ratio) in the quantity of the objects which can be placed in the each partial space PS.

In the object placement device 10, the placement destination determination function 24 refers to the relational information 12 based on the space designation information (space designation information noted at present) 15 which the space designation information generation function 22 generated as mentioned above. Accordingly, the placement destination determination function 24 determines whether or not the space designation information 15 indicates the partial space PS included in the relational information 12. [0043]

And when the space designation information 15 noted at present does not indicate any partial space PS as a result of the above-mentioned determination, the placement destination determination function 24 gives a re-calculation order 16 which directs to generate new space designation information 15 to the space designation information generation function 22. On the other hand, as a result of the above-mentioned determination, when it is detected that the space designation information 15 noted at present indicates any partial space PS, the placement destination determination function 24 specifies the placement destination identifier AID associated with the detected partial space PS by referring to the relational information 12. And the placement destination determination function 24 outputs placement destination designation information 17 representing that the placement destination 14 which corresponds to the specified placement destination identifier AID is determined as a placement destination of the object.

A meaning of a word that the space designation information 15 indicates a partial space PS is explained hereinafter. In the present exemplary embodiment, “indicate” means that a partial space PS exists in a zero- or more-dimensional space specified by the space designation information 15. That is, when one partial space PS exists in a zero- or more-dimensional space, the space designation information 15 indicates the partial space PS. When a plurality of partial spaces PS exists in a zero- or more-dimensional space which the space designation information 15 indicates, the placement destination determination function 22 selects any one of the plurality of partial spaces PS by executing an optional algorithm. Because a general method is adoptable currently about an algorithm adoptable for that selection, a detailed description thereof in the present exemplary embodiment will be omitted.

The identifier information 11 and the relational information 12 may be set up from the outside, or the object placement device 10 may generate them itself.

According to the object placement device 10 explained above, when a plurality of objects is placed in respective placement destinations, an approximate balance in the quantity of the objects which should be placed in each related destination can be determined by a relatively simple processing configuration, and objects that must be moved can be kept to a minimum when placement destinations increase or decrease.

In the following descriptions of the present application, space designation information (space designation information 15 in the present exemplary embodiment) generated based on identification information (identifier information 11 in the present exemplary embodiment) adoptable for an object which should be determined a placement destination is possible to indicate a set of zero- or more-dimensional spaces. And in the following descriptions, the indicated set of spaces will be called a “designated space DS”.

### First Exemplary Embodiment

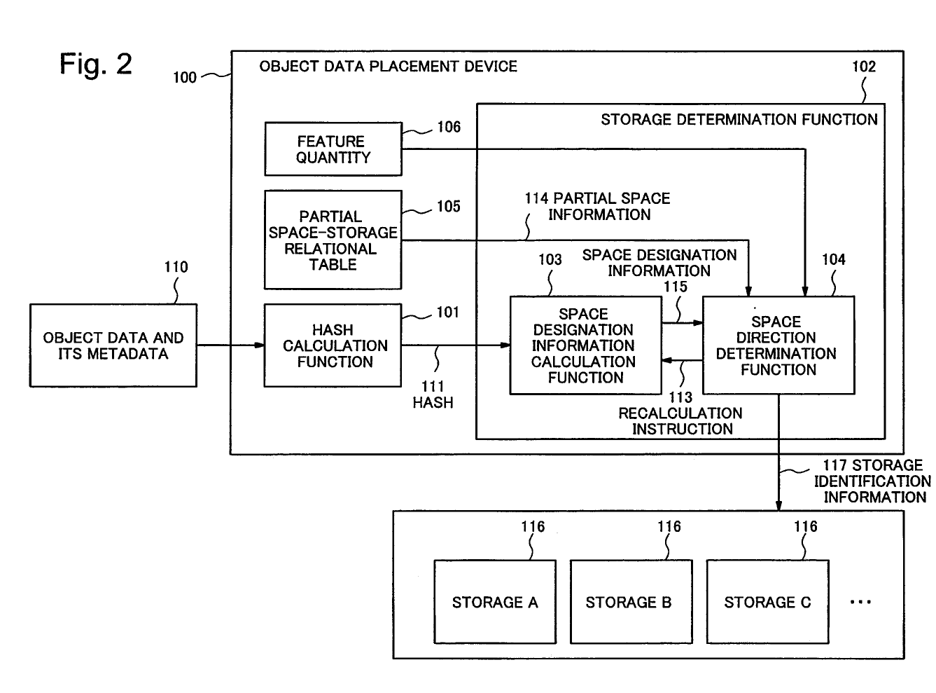

FIG. 2 is a block diagram showing a configuration of an object data placement device in a first exemplary embodiment of the present invention.

An object data placement device 100 is a device which determines a placement destination of data set (object data) as an object (placement target) to one or more storage 116 as a placement destination. In this exemplary embodiment, the object data composes at least any one of numerical data stored in the storage 116, and a software program (computer program) in which specific processing (a process, a function and an algorithm) was written.

In this exemplary embodiment, a plurality of storage 116 exists as shown notionally in FIG. 2. The storage 116 includes a configuration in which a plurality of storages which exists physically is connected by a communication line, a configuration in which a plurality of virtual storages is constituted inside the storage which exists physically, or a configuration of their combination (it is similar in each exemplary embodiment below).

The object data placement device 100 determines, by a specific calculation, a storage which should record (store) target object data from a plurality of storages 116 based on metadata which is identifier information specific to the object data. For example, the metadata is information such as an address, an object name, a directory name, or a file name. The metadata is included in object data and its metadata 110 relating to this exemplary embodiment, and it corresponds to the identifier information 11 in the exemplary embodiment (FIG. 1) mentioned above.

However, the object data placement device 100 according to this exemplary embodiment does not repeat generation of a random number (pseudo-random number) by using a hash as a seed (an initial value), but repeats generation of space designation information 115 by using the hash as a seed (an initial value). In this exemplary embodiment, the generation of the space designation information 115 performed repeatedly is performed repeatedly until a space designation information calculation function 103 outputs space designation information 115 which indicates a partial space PS corresponding to the generated space designation information. Here, the space designation information 115 corresponds to the space designation information 15 in the exemplary embodiment (FIG. 1) mentioned above.

According to a method explained in detail below in this exemplary embodiment, when the number of the storages was changed, change in the storage 116 which records object data is minimally suppressed. Here, for example, when a plurality of storages 116 exists physically, the number of storages represents number of the storages 116, and represents, when it is a virtual storage, virtual divisions of the physical storage.

According to the object data placement device 100 according to this exemplary embodiment, by a relatively simple processing configuration, an approximate balance (ratio) in the number of the objects stored in respective placement destinations can be set flexibly.

The object data placement device 100, in a broad sense, includes a hash calculation function 101 and a storage determination function 102. And the storage determination function 102 includes a space designation information calculation function 103 and a space direction determination function (determination function) 104. The object data placement device 100 can refer to the partial space-storage relational table 105, and a characteristic quantity 106 if needed (detailed description thereof will be made later). Here, the storage determination function 102 corresponds to the object placement device 10 in the exemplary embodiment (FIG. 1) mentioned above. The partial space-storage relational table 105 corresponds to the relational information 12 in the exemplary embodiment (FIG. 1) mentioned above.

In this exemplary embodiment, it is assumed that the object data and its metadata 110 are treated by a set outside the object data placement device 100. For example, this data in inputted into the object data placement device 100 in response to a write instruction to the storage 116 being issued in an external device.

When at least metadata in the object data and its metadata 110 can be referred to, it may be a system configuration that the object data itself is not inputted into the object data placement device 100, it is provided directly to an optimal storage 116 which the object data placement device 100 determined. In the object data placement device 100, a device configuration with which the metadata of the object data is generated based on the object data may be adopted.

The hash calculation function 101 outputs a hash (hash value) 111 by performing a hash operation, based on the metadata of the object data and its metadata 110. For the hash operation by the hash calculation function 101, it is possible to apply an operation which outputs the metadata as it is, or an operation which outputs it after performing suitable processing which is a general method currently. Here, the hash 111 is an example of the space designation information generated based on the metadata which is information specific to the target object data.

The storage determination function 102 outputs storage identification information 117 by performing processing procedures described below at least based on the hash 111 and partial space information 114. In that case, the storage determination function 102 may refer not only to the hash 111 and the partial space information 114, but also to the characteristic quantity 106. This characteristic quantity 106 is information representing the feature of the object data specified according to the type (attribute) of the object data among object data and its metadata 110, and when numerical expression thereof is possible, various kinds of information can be adopted. As for the characteristic quantity 106, a description thereof is added to the end of the description of this exemplary embodiment.

In the following description, an example in which the space WS and the partial space PS which the object data placement device 100 treats are applied to a one-dimensional space is explained from convenience of explanation. However, the present invention explained taking the present exemplary embodiment as an example is not limited to the one-dimensional space and is also applicable to a multi-dimensional space of two- or more-dimension. As a processing configuration in a case of a multi-dimension, it is assumed a device configuration that processing in a one-dimensional space described below is performed individually about each dimension which composes the multi-dimension, and a value (information) which satisfies conditions in the respective dimensions at the same time is selected.

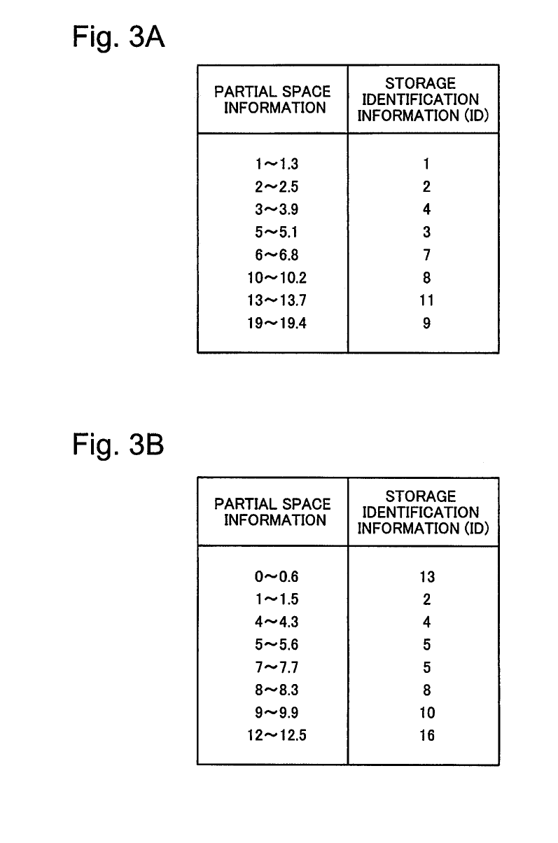

The partial space information 114 is information obtained by a reference of the partial space-storage relational table 105. Here, the partial space information 114 and the partial space-storage relational table 105 are explained with reference to FIG. 3A and FIG. 3B.

FIG. 3A and FIG. 3B are charts exemplifying a partial space-storage relational table according to the first exemplary embodiment of the present invention. As exemplified notionally in FIG. 3A and FIG. 3B, the partial space information 114 representing a partial space PS in a O- or more-dimensional space shown in the left column of the table, and the storage identification information (storage identifier (ID)) 117 shown in the right column of the table are associated in the partial space-storage relational table 105. Here, the partial space information 114 corresponds to the identifier information 12 mentioned above with reference to FIG. 1. The storage identification information 117 corresponds to the placement destination designation information 17 mentioned above with reference to FIG. 1.

And the space WS where each partial space information 114 illustrated in FIG. 3A is a one-dimensional continuous space. That is, each partial space information (partial space PS) 114 is a range (an area) allocated in the one-dimensional space WS and is associated with the storage identification information in one to one.

However, each of partial space information 114 and the storage identification information 117 do not have to be related in one to one. That is, in an example shown in FIG. 3B, the identical storage ID (=5) is associated with 5-5.6 and 7-7.7 for the range of the partial space information as the storage identification information 117. Thus, in the partial space-storage relational table 105, an identical storage can be allocated by the storage identification information 117 to a plurality of partial spaces PS whose ranges (areas) represented by the partial space information 114 are different from each other. More specifically, in this exemplary embodiment, for example, when the storage 116 corresponding to the storage ID=5 has a large storage capacity compared with that of other storage 116, a plurality of partial spaces PS can be allocated thereto as shown in FIG. 3B.

Accordingly, according to this exemplary embodiment, the number of the object data stored in the storage corresponding to storage ID=5 can be made larger than the number of the object data stored in other storages. In other words, the object data placement device 100 according to this exemplary embodiment can determine easily an approximate balance (ratio) between the number of object data stored in a specific storage, and the number of object data stored in other storages with the partial space-storage relational table 105.

That is, when using the partial space-storage relational table 105 mentioned above, the object data placement device 100, even when the recording (storage) capacity of the plurality of storages 116 which is a placement destination is remarkably different from each other, is able to perform the most suitable object data placement in consideration of the storage capacity of the each storage. Contrary to the example shown in FIG. 3B mentioned above, the storage identification information 117 is able to indicate an area of a plurality of storage devices.

The partial space-storage relational table 105 may be set in a suitable timing from the outside of the object data placement device 100, or the object data placement device 100 may generate it by itself. Or, the partial space-storage relational table 105 may be registered to the object data placement device 100 by a user by using a UI (user interface) not shown in FIG. 2

In the storage determination function 102, the space designation information calculation function 103 generates space designation information 115 by using a hash 111 as a seed (an initial value). The space designation information 115 is information which specifies the zero- or more-dimensional space on the space WS which the object data placement device 100 adopts. As an example of the space designation information 115, a single numeral (for example, when a space is one-dimension) which specifies the zero-dimensional space (a point) on the space WS, or a plurality of numerals (for example, when a space is two- or more-dimension, or when the space designation information 115 is a line, an area, a space or a multi-dimensional space) is considered.

The space designation information calculation function 103 generates a space designation information group in which the generated space designation information 115 does not have the approximate regularity but has reproducibility. Here, in order to simplify the explanation, it is assumed that the space designation information calculation function 103 generates a sequence in which the generated space designation information 115 does not have approximate regularity but has reproducibility, and each numerical value composing the sequence is the real number. In this case, the space designation information calculation function 103 specifies a position of a point on the one-dimensional space in which the real numbers continue.

Here, as an algorithm which the space designation information calculation function 103 adopts, if it is an algorithm which generates the same space designation information group when the seed is the same, optional algorithms can be adopted. However, preferably, as the space designation information calculation function 103, an algorithm which generates space designation information 115 capable of specifying a part of the space WS approximately uniform can be adopted (it is similar also in each exemplary embodiment described below). The reason is because when the space designation information 115 that is outputted does not specify a space by an approximately uniform distribution probability, it becomes difficult to adjust a balance in a quantity of the object data stored in the each storage by using the difference in the size of the partial space PS which the partial space information 114 corresponding to each storage 116 indicates.

That is, according to this exemplary embodiment, by making to specify a part of the space WS with more uniform distribution probability as a precondition, and by using the difference in the difference in the size of the partial space PS which the partial space information 114 corresponding to the each storage 116 indicates, an approximate balance in the number of the object data stored in the each storage can be adjusted more correctly.

Preferably, the state that the designated space DS of the space designation information 115 contains (includes) all the partial spaces PS may be established. When such state is established, by using the difference in the size of the partial space PS which the partial space information 114 corresponding to the each storage indicates, the approximate balance in the number of the object data stored in the each storage can be adjusted. On the other hand, when the inclusion state is not established, it is difficult to adjust the balance in the quantity of the object data stored in the each storage as mentioned above.

In the storage determination function 102, the space direction determination function 104 determines whether the space designation information 115 obtained from the space designation information calculation function 103 indicates the partial space DS included in the partial space-storage relational table 105 based on the partial space information 114. As a result of the determination, when the partial space DS which the space designation information 115 indicates exists in the partial space-storage relational table 105, the space direction determination function 104 outputs the storage identification information 117 detected from the partial space-storage relational table 105. As a result, an object data placement device 100 according to this exemplary embodiment can decide that target object data should be arranged in storage 116 with the storage ID corresponding to the storage identification information 117.

On the other hand, as a result of the determination, when the space designation information 115 does not indicate the partial space DS included in the partial space-storage relational table 105, the space direction determination function 104, by sending a re-calculation order 113 to the space designation information calculation function 103, orders generation of new space designation information (next space designation information) 115 to the space designation information calculation function 103.

When the space designation information 115 indicates the partial space DS included in the partial space-storage relational table 105, it may be configured so that the indicated partial space may be one certainly, or any one from a plurality of partial spaces DS may be selected. Because a general method can be adopted as an algorithm which selects one partial space from a plurality of partial spaces DS at present, the detailed description thereof is omitted in this exemplary embodiment.

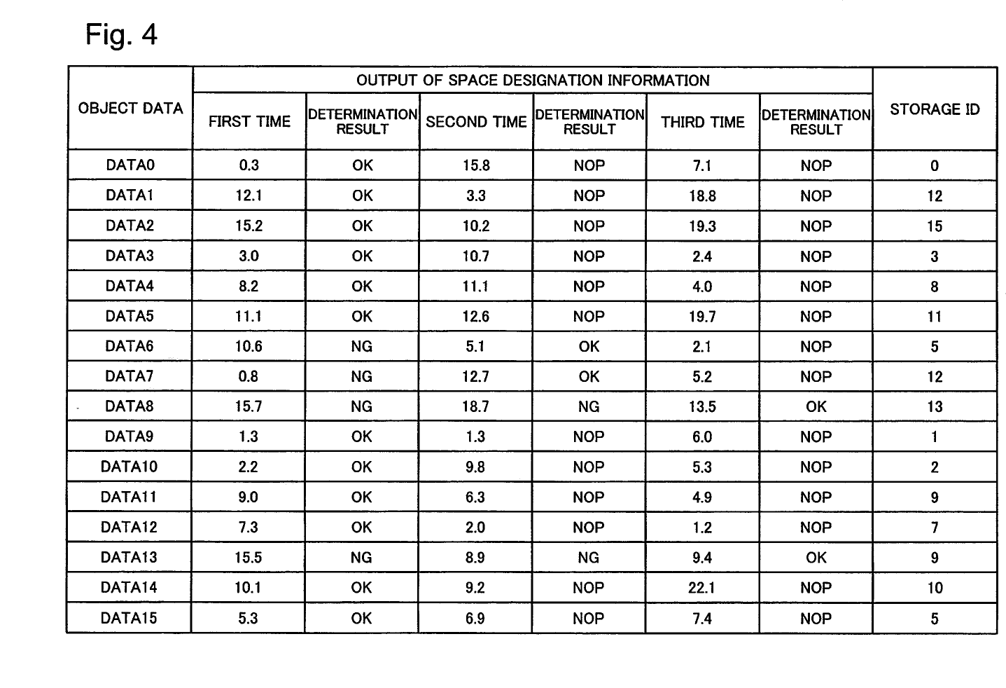

Next, an operation of the object data placement device 100 with the device configuration mentioned above is explained more specifically with reference to FIGS. 4, 5 and 6.

FIG. 4 is a chart explaining a placement operation of object data by the object data placement device according to the first exemplary embodiment of the present invention. An example shown in FIG. 4 shows a situation that the object data placement device 100 has placed sixteen object data (DATA0-DATA15) in sixteen empty storages (storage ID=0-15) 116 as an initial state first. It is assumed that these sixteen storages 116 are allocated in advance as partial spaces PS having numerical value ranges in the one-dimensional space WS in which a position in a space is expressed by one real number.

Here, as a specific example of the above-mentioned allocation, it is assumed that for example, in seven storages 116 whose storage IDs are ID=0-6 in sixteen storages 116, a partial space which is set a position (that is, 0, 1, . . . , 6) replaced on a one-dimensional space WS (a number line) by making a number indicating ID (identifier) of the storage into a numerical value as a starting point, and is set a position in which a numerical value made 0.4 increment in the direction which becomes big from the starting point as a terminal point is allocated, respectively.

And it is assumed that in other nine storages 116 whose storage IDs are ID=7-15 in sixteen storages 116, a partial space which is set a position (that is, 7, 8, . . . , 15) replaced on the one-dimensional space WS (the number line) by making a number indicating ID (identifier) of the storage into a numerical value as a starting point, and is set a position in which a numerical value made 0.8 increment in the direction which becomes big from the starting point as a terminal point is allocated, respectively.

When the above-mentioned allocation is performed, in the environment in which the designated space DS of the space designation information calculation function 103 includes the partial spaces PS separately allocated in the sixteen storages 116, the length of each line segment separately allocated to the one-dimensional space WS (the number line) represents a storage capacity of the each storage 116. And in the environment, it is indicated that each storage whose storage ID is ID=7-15 has a twice storage capacity compared with each storage whose ID is ID=0-6.

It will be returned to the description of the specific example shown in FIG. 4. The space designation information calculation function 103, as an example, outputs a random number which is the real number from 0 to 31 at random. When the outputted random number indicates a partial space PS allocated to each of storage 116, the space direction determination function 104 determines that the corresponding storage exists by referring to the partial space-storage relational table 105. That is, in FIG. 4, the description in “First time”, “Second time”, and “Third time” indicates the output result (115) outputted in k-th time (in that example, 1≦k≦3) when the in “the first time”, “the second time”, “the third time” when the space designation information calculation function 103 repeatedly generates a random number (space designation information) which is the real number.

In the table shown in FIG. 4, “Determination result” represents a determination result by the space direction determination function 104. In FIG. 4, it is described as “OK” when it is determined that there is a corresponding storage, “NG” when there is no corresponding storage, and NPO” when it is not used for determining. And a right end column shown in FIG. 4 is an output result (storage identification information 117) as the storage determination function 102 (object data placement device 100), and each number represents the storage ID for fifteen storages.

For example, referring to DATA0, because the first random number output value is 0.3, when the allocation example of the one-dimensional space WS mentioned above is adopted, the numerical value range corresponding to the storage with the storage ID=0 is 0 to 0.4. Accordingly, the first random number output value indicates the partial space PS corresponding to the storage with the storage ID=0. Therefore, the determination result is “OK” as shown in FIG. 4. That is, the placement destination for the object of DATA0 is the specific storage 116 corresponding to the storage ID=0.

Next, referring to DATA6, because the first random number output value is 10.6, when the allocation example of the one-dimensional space WS mentioned above is adopted, because the determination result is “NG” and the second random number output value is 5.1, the determination result is “OK”. Therefore, the placement destination for DATA6 is the storage corresponding to the storage ID=5.

And by the similar processing configuration, in a case of DATA8 and DATA13, the random number output values up to the second time are “NG”, and finally the third random number output value is determined as “OK”. Therefore, in a case of DATA8 and DATA13, as shown in FIG. 4, the space direction determination function 104 determines that the storages corresponding to the storages ID=11 and 9 are the placement destinations, respectively.

Next, a case where a storage which can store objects was added is considered.

A situation where each of the storage 116 has stored object data maintaining a pre-specified proportion (balance, ratio) is considered. In this situation, when a storage is added newly, each storage including the newly added storage needs to maintain the situation of object data being stored, maintaining the pre-specified proportion. For that, a part of the object data already stored in other storages must be moved to the newly added storage which has not yet stored object data. In this case, it is ideal if the proportion is maintainable by moving minimum object data only to the newly added storage without generation of movement of the stored object data between the existing storages.

The designation of the proportion (balance, ratio) between the respective storages of the number of the object data which the respective storages 116 store may be performed, for example, when allocating each partial space PS in the space WS. And as for the allocation of the partial space PS, registration of the partial space-storage relational table 105 is listed. More specifically, the designation and the change (updating) of this proportion (balance, ratio) in this exemplary embodiment should just be realized by a user (operator) and an external device, for example, which are monitoring an operation situation of the each storage 116 by changing (updating) the registered contents in the partial space-storage relational table 105. And as the timing of that change (update), for example, the time of the system development, or maintenance thereof, or an event such as addition or reduction of the storage 116 is assumed.

According to the object data placement device 100, the space designation information 115 indicating the partial spaces PS corresponding to respective storages which had already existed when the sets of the storages were m among space designation information 115 to which it should be determined by the space direction determining function 104 that corresponding partial spaces PS exist after storages 116 increase from m sets to n sets (m<n) are the same as that m sets of storages.

This is because, in this exemplary embodiment, the space designation information calculation function 103 has a characteristic of outputting the same space designation information 115 to the object data corresponding to the same hash 111. For this characteristic, it is because the space designation information calculation function 103, before the space designation information 115 indicating the partial space PS corresponding to each storage which had already existed before increasing from m sets to n sets are outputted, does not output the space designation information 115 indicating the partial spaces PS corresponding to other storages except the each storage which had already existed when they were m sets.

In other words about this, when the space designation information calculation function 103 outputs space designation information 115 indicating partial space PS corresponding to other storage different from each storage which had already existed in the case of m sets, it means that a situation that object data stored in any storage in the case of m sets is changed into another storage generates. Because this situation means that an unnecessary movement of object data between the storages generates, it is not desirable, but it is avoidable according to this exemplary embodiment.

Note that, the space designation information calculation function 103, before outputting the space designation information 115 indicating the partial space PS corresponding to the each storage which existed when the storages were m sets, may output the space designation information 115 indicating the partial space PS corresponding to other storage which did not exist when the storages were m sets.

That is, in this exemplary embodiment, among the space designation information 115 which should be determined that corresponding partial space PS exists thereto in the space direction determination function 104 when increasing in number of storage, a change is generated only in the space designation information 115 indicating the partial space PS corresponding to the newly added storage, and the space designation information 115 indicating the partial spaces PS corresponding to the storages which had existed originally are not changed. This means that object data to which movement generates are the minimum when the storages increase. After the storages increase, a quantity of object data which each storage stores is approximately proportional to a width of the partial space PS corresponding to the each storage.

Next, a case where the number of the storages 116 decreases is considered.

A situation where each storage holds object data by a pre-specified proportion is considered. In this situation, when a specific storage decreases, in order for each storage except the specific storage to maintain the situation of holding object data by the specified proportion, the object data which is the reduction target held must be moved to the remaining storages (that is, the storages which are not reduction targets). At that time, when processing with which movement of object data already stored between existing storages is not generated and only object data stored in the specific storage which is the reduction target is moved (distributionally placed) to the remaining storages can be realized, it is ideal because the prespecified proportion can be maintained by the minimum data movement.

According to the object data placement device 100, among the space designation information 115 which should be determined in the space direction determination function 104 that corresponding partial spaces PS exist thereto before the storages are decreased from n sets to m sets (m<n), the change is generated only in the space designation information 115 which indicates the partial space PS corresponding to the specific storage which ceases to exist after the reduction. This is because the space direction determining function 104 determines that the corresponding partial space does not exist to the space designation information 115 which indicates the partial space PS corresponding to the specific storage which ceased to exist when m sets of the storages remain. That is, in this exemplary embodiment, the space designation information 115 indicating the partial spaces corresponding to the storages which decreased to m sets are not changed, and is the same as the space designation information 115 indicating the partial spaces corresponding to n sets of storages before the reduction.

More specifically, among space designation information 115 which should be determined by the space direction determination function 104 that the partial space corresponding thereto exist before the storages are decreased to m sets, the change is generated only in the space designation information 115 indicating the partial space PS corresponding to the deleted specific storage, the space designation information 115 indicating the partial spaces PS corresponding the storages which are the storages which had already existed when the storages were n sets, and remains also after decreasing to m sets are not changed. This means that object data to which the movement generates is the minimum when storages decrease. After storages decrease in number, the quantity of the object data which each storage stores is approximately proportional to a width of the partial space PS corresponding to respective storages.

That is, according to this exemplary embodiment, when the storages 116 increase or decrease, an ideal operation which can suppress the object data that receive the influence thereof at a minimum can be realized. According to this exemplary embodiment, the object data after the movement is distributionally placed in the each storage which exists after the number of the storages increases or decreases in the state near the pre-specified balance (ratio).

Hereinafter, specific examples are described about cases where the number of the storages 116 mentioned above increases, and decreases, respectively.

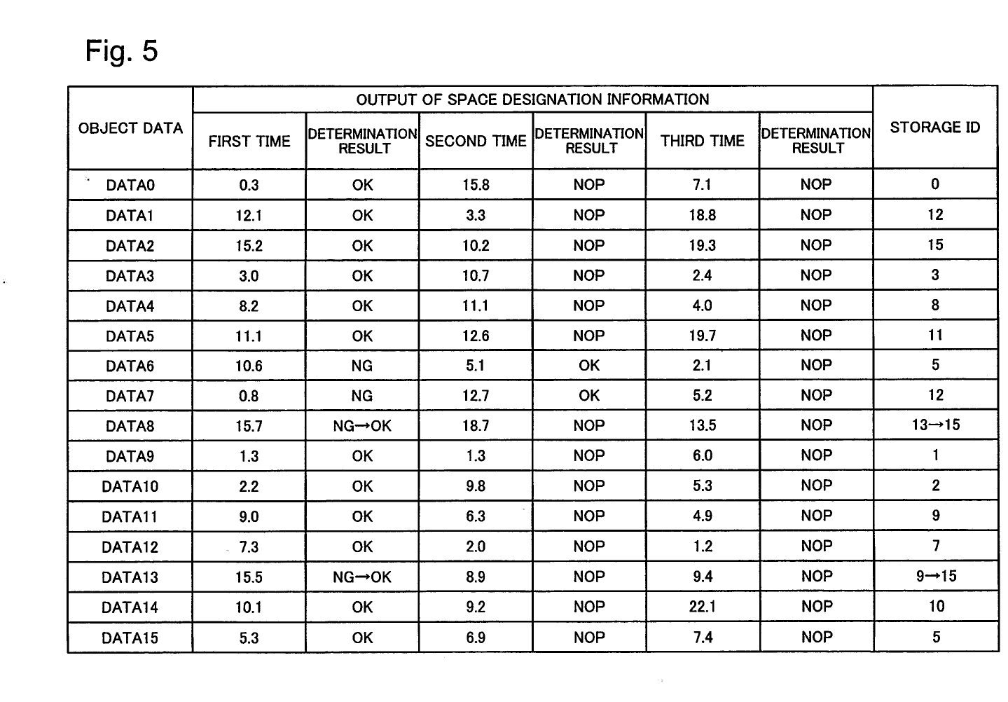

FIG. 5 is a chart explaining an operation when adding a storage from the placement state shown in FIG. 4 by the object data placement device according to the first exemplary embodiment of the present invention. That is, in the example shown in FIG. 5, the operation of the object data placement device 100 is represented when it is determined that the partial space PS (partial space information) corresponding to the new storage was added in the partial space-storage relational table 105 in order to add a sixteenth new storage (in this example, the storage 116 corresponding to the storage ID=15)

The partial space PS corresponding to the storage whose storage ID is 15, like the allocation method of the partial space PS with respect to each storage in this exemplary embodiment mentioned above, is allocated as a line segment whose starting point is 15, and whose terminal point is the position incremented by +0.8 therefrom on the number line of the real number indicating the space area WS. That is, in the partial space-storage relational table 105, the partial space information 15.0-15.8 are related to the storage ID=15.

The basic view point of the table shown in FIG. 5 is similar to the case of FIG. 4 mentioned above. And in FIG. 5, the part changed from the state shown in FIG. 4 is expressed by connecting the situation before change and the situation after change with an arrow. That is, according to FIG. 5, the DATA8 and the DATA13 are moved to the newly allocated storage (storage ID=15 equivalent to the partial space 15).

Thus, the object data placement device 100 needs to recognize that the contents of the partial space-storage relational table 105 were updated by the different contents from the time of referring to it last time. And the object data placement device 100 repeats generation of the space designation information 115, and determination of whether the partial space PS which the space designation information indicates exists. And the object data placement device 100, when confirming that the noted space designation information 115 indicates the new partial space PS, determines that the storage corresponding to the partial space is the new placement destination of the object data whose placement destination has been determined.

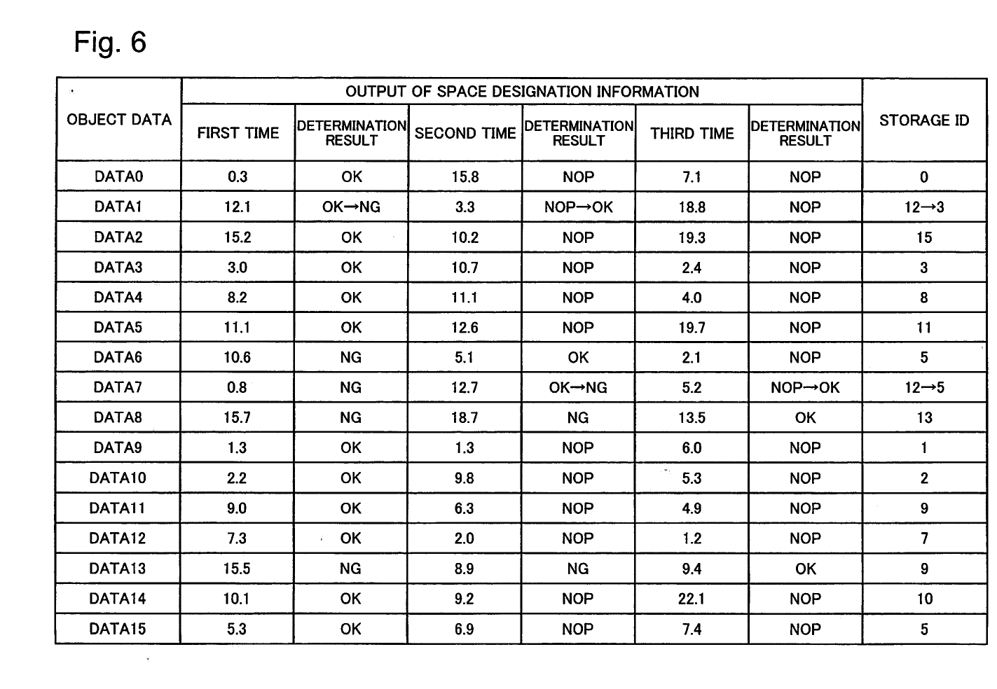

FIG. 6 is a chart explaining an operation when reducing the storage from the placement state shown in FIG. 4 by the object data placement device according to the first exemplary embodiment of the present invention. That is, in the example shown in FIG. 6, the operation of the object data placement device 100 is represented when it is determined that the partial space PS corresponding to the storage was reduced from the partial space-storage relational table 105 in order to reduce the storage 116 corresponding to the storage ID=12.

The basic view point of FIG. 6 is also similar to the cases of FIG. 4 and FIG. 5 mentioned above. However, in this case, one set is deleted from fifteen sets of the storages at the beginning, and they become fourteen sets. In FIG. 6, the part changed from the state shown in FIG. 4 is represented using an arrow like the case of FIG. 5. That is, according to FIG. 6, it is indicated that two object data (DATA1 and DATA7) which were stored in the storage (storage ID=12) to be deleted are changed storages for storing them.

Thus, the object data placement device 100 needs to recognize that the contents of the partial space-storage relational table 105 were updated by the different contents from the time of referring to it last time. And the object data placement device 100 repeats the generation of space designation information 115, and the determination of whether a partial space PS which he space designation information indicates exists. And the object data placement device 100, when confirming that the noted space designation information 115 indicates a new partial space, determines that the storage corresponding to the partial space is a new placement destination of the object data whose placement destination has been determined.

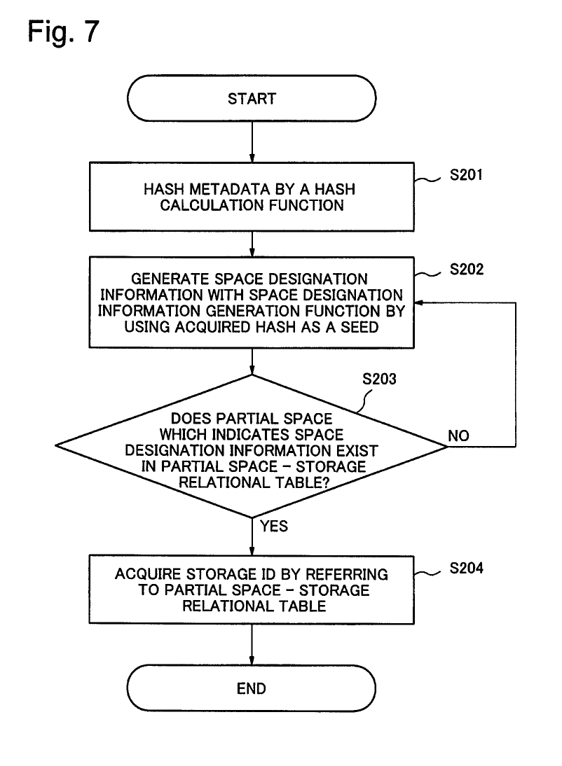

Next, placement processing of object data which the object data placement device 100 performs in order to realize a series of operation relating to this exemplary embodiment mentioned above, is explained with reference to FIG. 7.

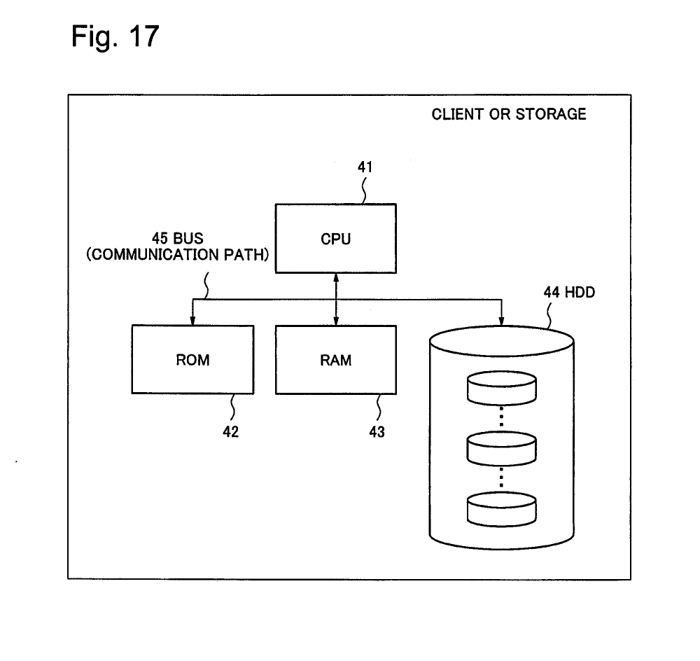

FIG. 7 is a flow chart showing placement processing of object data which the object data placement device according to the first exemplary embodiment of the present invention performs. Here, when the object data placement device 100 is realized by a computer (information processing device), a CPU (Central Processing Unit) of the computer will execute processing of each step explained below (the details are described later with reference to FIG. 17).

Step S201: The hash calculation function 101, in target object data and its metadata 110, acquires a hash 111 by performing a hash operation based on the metadata. Here, the target object data is object data which needs to be determined a storage which should store (the same hereinafter). And the metadata is information specific to object data corresponding to the metadata, such as an address, an object name, a directory name or a file name. And the hash calculation function 101 gives the hash 111 to the space designation information calculation function 103.

Step S202: The space designation information calculation function 103 sets the acquired hash 111 to a seed (an initial value), and generates the space designation information 115 by using the seed. And the space designation information calculation function 103 gives space designation information 115 to the space direction determination function 104.

Step S203: The space direction determination function 104, by referring to information 114 sent from the partial space-storage relational table 105, determines whether a partial space which the space designation information 115 indicates exists in the partial space-storage relational table 105.

When the space designation information 115 generated at Step S202 does not indicate the partial space which exists in the partial space-storage relational table 105 (NO at Step S203), the processing is returned to Step S202. And the space designation information calculation function 103 generates next space designation information 115 newly.

On the other hand, when the space designation information 115 generated at Step S202 indicates the partial space which exists in the partial space-storage relational table 105 (YES at Step S203), the space direction determination function 104 outputs the storage identification information (storage ID) 117 which is associated with the partial space which the space designation information 115 indicates. That is, the storage identification information 117 is the information which specifies the storage 116 which should store the target object data.

A case where the space area WS and the partial space PS which the object data placement device 100 treats are multi-dimensional spaces is explained hereinafter. In the example mentioned above with reference to FIG. 3A, FIG. 3B and FIG. 7, in order to simplify the explanation, the case where the space area WS and the partial space PS are the one-dimensional space was explained. However, the present invention explained taking this exemplary embodiment as an example is not limited to the one-dimensional space and is also applicable to multi dimensions. This point is explained with reference to FIG. 8, FIG. 9A and FIG. 9B.

FIG. 8 is a diagram explaining a case where the object data placement device according to the first exemplary embodiment of the present invention is applied to a two-dimensional space exemplarily. In the two-dimensional space (two-dimensional coordinate) shown in FIG. 8, the horizontal axis is characteristic quantity (characteristic quantity 106 mentioned above) and the vertical axis shows a random number. A plurality of two-dimensional partial spaces (PS) A to K is allocated in this two-dimensional space (WS).

More specifically, when a plurality of partial space PS is placed as shown in FIG. 8, for example, on the two-dimensional space, the space designation information calculation function 103 determines the space designation information 115 which should be outputted about the target object data based on a parameter in the two-dimension (two axes). That is, in the space designation information 115 in this case, the one dimension among the two dimensions is determined based on the characteristic quantity 106 for the target object data by referring to the numerical value range 0.0-1.0 illustrated in FIG. 8. And the remaining one dimension is determined based on a random number which made the storage ID (placement destination identifier AID) for the target object data a seed. The numerical value range that the random number which the space designation information calculation function 103 generates in this example can adopt is 0-4 as shown in FIG. 8, for example. That is, the space designation information calculation function 103 repeats generation of a random number until one of partial space PS allocated to the two-dimensional space WS is indicated.

And in the example shown in FIG. 8, the object data with the characteristic quantity of 0.5 is placed in the storage 116 corresponding to the partial space B certainly. The object data with the characteristic quantity of 0.3 is placed in any one of storages 116 corresponding to the partial space B or the partial space F by the same probability.

In the example shown in FIG. 8, the object data with the characteristic quantity of 0.7 is placed in the storage 116 corresponding to the partial spaces C, G or J by the same probability. For example, when the storage 116 corresponding to the partial space C is excluded from a placement target, the partial space C disappears from the two-dimensional space WS. In this case, the object data placement device 100 moves the object data which was stored in the storage corresponding to the disappeared partial space C to the storage corresponding to the partial space G or the partial space J. And in the movement thereof, the object data which is the moved target is placed in the storage corresponding to the partial space G or the storage corresponding to the partial space J in the same probability. In such case, according to the object data placement device 100 of this exemplary embodiment, the object data to be moved can be suppressed in a minimum.

And the object data with the characteristic quantity of 0.9, before the partial space L shown by a dashed line in FIG. 8 is added, is placed in the storage corresponding to the partial space D or the partial space H by the same probability. After that, when the storage corresponding to the partial space L is added as a placement target, the partial space L is allocated newly to the two-dimensional space WS shown in FIG. 8. Thereby, the part of the object data stored in the storage corresponding to the partial space D or the partial space H will be moved to a storage corresponding to the partial space L. In that case, the object data which became the moved object is placed in the storages corresponding to the three partial spaces D, H, and L respectively in the same probability.

That is, the space designation information calculation function 103, by referring to the characteristic quantity 106 which composes the space axis in the multi-dimensional space and characterizes the attribute of the object, can limit (specify) the range of the space when generating the space designation information 115, according to this exemplary embodiment.

The change in the allocation of the partial space PS should also be realized by the change (update) in the registered content of the partial space-storage relational table 105 in a case of the above-mentioned two dimensions. Thus, it is found that the object data placement device 100 according to this exemplary embodiment, when handling the two-dimensional space, is able to deal with the fluctuation of the storages as mentioned above.

That is, as the examples described with reference to FIGS. 4 to 6 suggest, when the space WS is the one-dimensional space, irrespective of the kind of the object which is a placement target, processing (that is, object data placement) according to the size in the partial space PS which the length of the line segment allocated on the one-dimensional number line represents is performed. In contrast, when the partial space PS which represents the storage (placement destination) as illustrated in FIG. 8, is allocated to the two-dimensional space composed of the random number axis and the characteristic quantity axis, the characteristic quantity (106) can be further used in the generation of the space designation information 115 (that is, when any one of partial spaces PS is selected). This indicates that the space designation information calculation function 10 can target not only a size of each partial space PS but a part of the partial space PS further limited corresponding to a type (attribute) of the object which is a placement target when generating the space designation information 115. In other words about this, because it indicates that a processing target can be limited appropriately when generating (that is, selecting any one of partial spaces) space designation information 115, the treatment efficiency as the object data placement device 100 can be improved.

Further, in the example explained with reference to FIG. 8, the configuration in which one of two axes composing the two-dimensional space is assigned to the characteristic quantity was explained. However, the present invention is not limited to the configuration thereof and is also applicable in a multi-dimensional space in which a plurality of kinds of feature quantities is assigned to a plurality of axes.

Next, a case where a three-dimensional space is adopted as a space WS, and two axes among three axes which compose the three-dimensional space were set as random numbers is explained.

FIG. 9A and FIG. 9B are diagrams explaining a case where the object data placement device according to the first exemplary embodiment of the present invention is applied to a three-dimensional space exemplarily. That is, in the three-dimensional space (three-dimensional coordinate) WS separated and shown in FIG. 9A and FIG. 9B, the X axis in the X-Y plane shown in FIG. 9A is a random number A (first random number) and the Y axis thereof is a random numbers B (second random number), and the front direction of the paper surface is the +Z axis direction. On the other hand, in the Y-Z plane shown in FIG. 9B, the Y axis is a random number B and the Z axis is the characteristic quantity (106), and the front direction of the paper surface is the +X axis direction.

As illustrated in FIG. 9A, the X-Y plane is divided to two areas (I and II) as represented by two kinds of slant lines in the same diagram. And in the three-dimensional space WS, A to F as partial spaces PS are allocated in the Y-Z plane shown in FIG. 9B. That is, it is assumed that the partial spaces A to F spread over the X axis direction in a mode in which the allocation state of the plurality of partial spaces (A to F) shown in the Y-Z plane moved in parallel.

In the case when the object data placement device 100 adopts such three-dimensional space, it is assumed that at first, only one area I was set on the X-Y plane which composes a combination of random numbers A and B. In this case, it is assumed that the space designation information calculation function 103 generates a next random number newly when a value outside the partition of the area I is calculated.

And in this case, when a case where the characteristic quantity of a target object is 0.5, as shown in FIG. 9B, this object is placed in the storage 116 corresponding to the partial space A or the partial space B. In this placement, a possibility placed in the storage corresponding to the partial space A is two times of a possibility placed in the storage corresponding to the partial space B. The difference in these possibilities (probability) is caused by the asymmetric shape of the area I in the premise assuming that only the area I was specified on the X-Y plane at first as mentioned above.

Next, a case when the area II was further set in addition to the area I in the X-Y plane shown in FIG. 9A is considered. In this case, it is assumed that when a value outside the partition of the area I and the area II is calculated, the space designation information calculation function 103 generates a next random number newly. In this case, when a case where the characteristic quantity of the target object mentioned above is 0.5 is also considered, the object is placed in the storage 116 corresponding to the partial space A or the partial space B like the example mentioned above. However, in this case, because the synthesis area of the area I and the area II set in the X-Y plane is the rectangle shape, a possibility that the object is placed in the storage corresponding to the partial space A and a possibility that the object is placed in the object corresponding to the partial space B become identical.

And when the value range that a random number can adopt is changed from the area I to the area (I+II) as mentioned above, the quantity of the objects to which the storage of the placement destination is changed with the change is as follows.

That is, when only the area I was set, the quantity of the objects placed in the storage corresponding to the partial space A is in the state of being approximately twice as large as the quantity of the objects placed in the storage corresponding to the partial space B. Thereafter, in accordance with the area II being set in addition to the area I, the quantity of the objects placed in the storage corresponding to the partial space A and the quantity of the objects placed in the storage corresponding to the partial space B will be approximately in the same state. In this exemplary embodiment, the object data placement device 100, in order to realize the state, is able to determine to move the objects of a required minimum quantity.

As mentioned above, when multiple axes, as the random number axis, are adopted instead of the one axis in handling the multi-dimensional space WS in the object data placement device 100, there is the following advantage.

That is, in a case of the device configuration for the random number axis being one axis, the space designation information calculation function 103 is only capable of generating all random numbers in the same probability. Therefore, in such device configuration, when the quantity of object data stored in the storage 116 is changed, there is only an option which changes the size (the length of the numerical value range corresponding to the storage capacity of the storage) of the partial space PS allocated in the one-dimensional random number axis. In contrast, in a case of the device configuration for the random number axis being multiple axes, the object data placement device 100 can change the partition in the space area (space area which will not recalculate a random number in the future) which the space designation information calculation function 103 in the multi-dimensional space formed by the multiple random number axes refers to for generating space designation information 115 as the change from the area Ito the area (I+II) on the X-Y plane shown in FIG. 9A. This change can be realized easily by changing (updating) the partial space-storage relational table 105 composed so that the multi dimensions can be expressed. Implementation itself of the partial space-storage relational table 105 in the case of the one-dimensional space illustrated in FIG. 3A and FIG. 3B in a device so that the multi dimensions can be expressed therewith can be realized by a relatively simple configuration change, without inviting increase of a processing load (processing cost).

Therefore, according to the device configuration for the random number axis being multiple axes, because the range which adopts the calculated random number can be changed easily and flexibly, a generation probability of the space designation information 115 which the space direction determination function 104 should adopt can be changed corresponding to a value of a random number. This indicates that a plurality of kinds of evaluation indices can be adopted in the object data placement device 100 by a relatively simple configuration change. And it is indicated that the object data placement device 100 which adopts this device configuration can change the quantity of the object data stored in the storage without changing the size in the storage area of the storage 116. That is, according to this exemplary embodiment, the space designation information calculation function 103, by referring to mutually different plural pseudo-random numbers which compose at least two space axes in the multi-dimensional space, can limit (specify) the range of the space at the time of generating the space designation information 115.

By the way, as an example of implementation using such a multi-dimensional space, for example, a case where an object which should be placed in a placement destination is a sensor output such as a GPS (Global Positioning System), for example, is assumed. In this case, because the sensor output includes position information (map information), the position information itself represents a specific position in the multi-dimensional space. Accordingly, in such case, when the object placement device 10 (object data placement device 100) itself can treat the multi-dimensional space (WS), the each object can be allocated as a partial space (PS) in the space (WS) which the object placement device (object data placement device) adopts by the same dimensional condition as the dimension which each object has.

That is, when an object including two-dimensional information, for example, using the object placement device 10 and the object data placement device 100 which adopt the one-dimensional space mentioned above in order to simplify the explanation, is placed, processing which converts two-dimensional information representing the each object to one-dimensional information is needed before processing which allocates each object in a partial space of the one-dimensional space is performed. Moreover, depending on a mode of the implementation, processing which converts one-dimensional information representing a determination result of a placement destination to two-dimensional information is needed. This indicates that a series of processing takes an extra time, and a processing load (processing cost) is large.

In contrast, in a case of a device configuration in which two-dimensional information representing the each object is allocated as a partial space PS of the two-dimensional space just as it is, the extra processing load does not generate. Therefore, according to the device configuration, a configuration of an object data placement device can be realized simply, and objects can be placed flexibly and at high speed. This is not the effect to be limited in the case where objects are expressed by two-dimensional information. That is, this effect can be received, when an object which should be determined a placement destination is n-dimensional information (n≧1), by adopting an object data placement device which treats the multi-dimensional space in which the n-dimensional information is allocated just as it is. More specifically, the number of dimensions in a multi-dimensional space may be the same as the number of kinds of a plurality of kinds of information that represents the object.

According to an object data placement device 100 by the first exemplary embodiment explained above, when a plurality of objects are placed in individual storages 116 (placement destinations), an approximate balance in the quantity of the objects which should be placed in each related placement destination can be determined by a relatively simple processing configuration, and when placement destinations increase or decrease, objects that must be moved can be kept to a minimum.

That is, in the storage determination function 102 of the object data placement device 100, the space designation information calculation function 103 can repeat generation of the space designation information 115. The space direction determination function 104, referring to the partial space-storage relational table 105, compares the generated space designation information 115 and the partial space included in the partial space-storage relational table 105. And the space direction determination function 104, corresponding to detecting the partial space which the space designation information indicates, determines the storage corresponding to the storage ID associated with the partial space to be the placement destination of the object data.

Accordingly, for example, according to this exemplary embodiment, an approximate balance (ratio) in the number of the object data stored in each of the storage can be set by a relatively simple device configuration compared with the technologies disclosed in the patent literatures 1 and 2, and the non-patent literatures 1 and 2 which were explained in the “background art” column. According to this exemplary embodiment, compared with the method disclosed in patent literature 3, it becomes possible to make scalability and efficiency compatible satisfactorily. Therefore, according to the method related to this exemplary embodiment, for example, also in a system which realizes a distributed storage by combining storages which have different storage capacities, for example, using a simple configuration, the object data can be placed without wasting the storage capacity.

### Modification of First Exemplary Embodiment

In the first exemplary embodiment mentioned above, although the single partial space-storage relational table 105 was used, it is not limited thereto. That is, based on the object data placement device 100, a device configuration which uses a plurality of partial space-storage relational tables appropriately according to the condition can also be assumed.

More specifically, for example, there may be a case to change s storage destination for the object data by an address. That is, a system in which a partition is provided corresponding to an address and a storage group which should store object data is changed for every partition is assumed. In such case, according to an address among a plurality of number-storage relational tables, a form which changes the used number-storage relational table is assumed.

Or, in the Key-Value Store, when the storage group which stores is changed, for each range of Key, a form for changing the number-storage relational table for every range of each Key is also assumed. That is, in this case, a storage determination function 102 can refer to a plurality of number-storage relational tables, and determines the storage which should place object data by referring to the number-storage relational table corresponding to the information among those number-storage relational tables based on information about the object data.

As a specific example which uses a plurality of partial space-storage relational tables appropriately, a specific example in consideration of protective level of object data is explained hereinafter.

That is, protective level needed may be different depending on object data. In such case, the level of the RAID (Redundant Arrays of Inexpensive Disks) method different depending on the storage can be set. And object data with a high required protective level can be stored in the storage which set a RAID method with high degree of multiplexing. On the other hand, object data with a low required protective level can be stored in the storage which set a RAID method with low degree of multiplexing. In this case, for example, two kinds of partial space-storage relational tables (hereinafter, referred to “the first relational table”, and “the second relational table”) are prepared instead of the partial space-storage relational table 105 shown in FIG. 3A and FIG. 3B.

That is, in the first relational table, a storage (storage identification information) which set a RAID method with high degree of multiplexing and a partial space are related. On the other hand, in the second relational table, a storage (storage identification information) which set a RAID method with low degree of multiplexing and a partial space are related. According to the form which uses such a plurality of partial space-storage relational tables appropriately, placement processing matching the protective level required for object data is realized.

Hereinafter, an operation of an object data placement device in consideration of a protective level of object data is explained with reference to the flow chart shown in FIG. 7 again.

First, the hash calculation function 101, in target object data and its metadata 110, acquires a hash 111 by performing a hash operation based on the metadata. (Step S201). In this modification, the protective level of corresponding object data is included in the related metadata. The space designation information calculation function 103 sets a hash 111 to a seed (an initial value) and generates space designation information 115 by using the seed (Step S202).

And the space direction determination function 104 selects any one of partial space-storage relational tables corresponding to the metadata among the first relational table and the second relational table based on the related metadata. And the space direction determination function 104, by referring to the partial space information 114 which is obtained from the selected partial space-storage relational table, determines whether or not the partial space which the space designation information 115 acquired from the space designation information calculation function 103 indicates exists in any one of partial space-storage relational tables corresponding to the metadata (Step S203).

When the space designation information 115 generated at Step S202 does not indicate the partial space which exists in the partial space-storage relational table selected at Step S203 (NO at Step S203), processing is returned to Step S202. And the space designation information calculation function 103 generates next space designation information 115.

On the other hand, when the space designation information 115 generated at Step S202 indicates the partial space which exists in the partial space-storage relational table selected at Step S203 (YES at Step S203), the space direction determination function 104 outputs storage identification information (storage ID) which is associated with the partial space which the space designation information 115 indicates as the storage identification information 117. As a result, the storage by which the target object data is stored is determined.

As information used as the space designation information 115, various things, such as a single numeral or a plurality of numerals (for example, various kinds of numerals, such as an integer and the real number) or an identifier which indicate an area on a space or a partial space including a single numeral or a plurality of numerals (for example, various kinds of numerals, such as an integer and the real number) or an identifier which indicate a coordinate on space, are considered. In the space designation information calculation function 103 which generates the space designation information 115, the same space designation information is always generated to the data with the same metadata, and when the generated space designation information are not correlated mutually (a mutually related degree is small), various calculation functions (operation modules) can be adopted.

In this exemplary embodiment, the configuration which uses a hash as a seed was explained as the example as mentioned above. However, the present invention is not limited to the configuration, and when it is the storage managed by using an address, for example, the address may be used as a seed.

### Second Exemplary Embodiment

Next, a second exemplary embodiment based on the object data placement device 100 according to the first exemplary embodiment mentioned above is explained. In the following explanation, this exemplary embodiment is explained focusing on the characteristic part thereof, and the explanation which overlaps about the same configuration as the first exemplary embodiment mentioned above is omitted.

The first exemplary embodiment mentioned above was premised that all the partial spaces PS registered in the partial space-storage relational table 105 are included in the designated space DS of the space designation information calculation function 103. In contrast, in this exemplary embodiment, a method which is not limited to such premise is described.

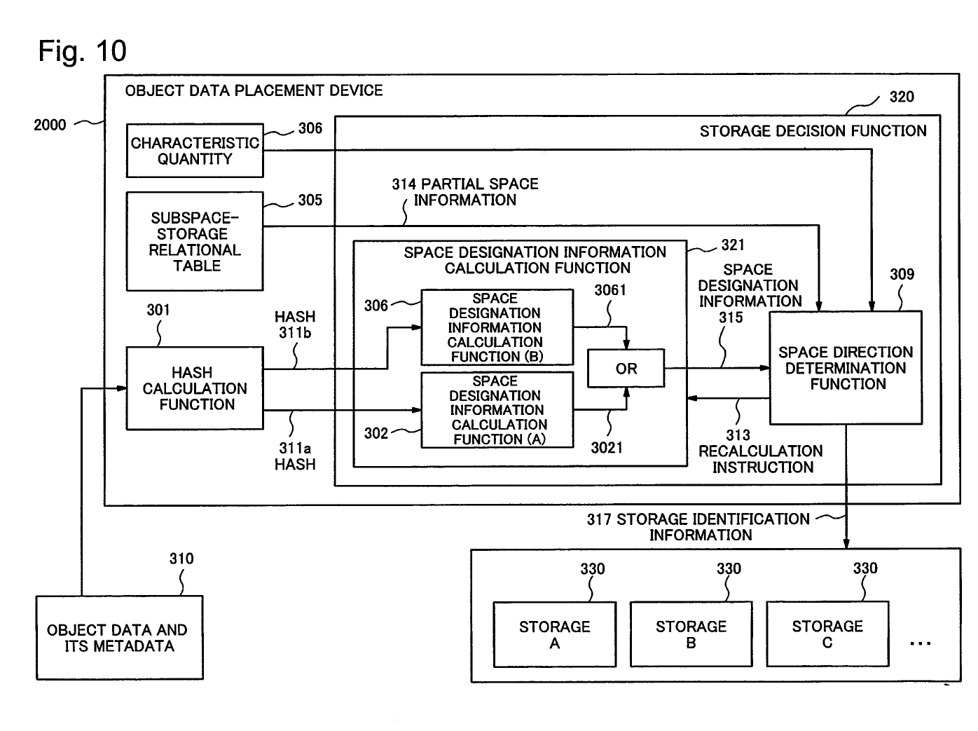

FIG. 10 is a block diagram showing a configuration of an object data placement device in the second exemplary embodiment of the present invention.

An object data placement device 2000 is a device which determines a placement destination of data (object data) as an object (placement target) to the storage 330 as a placement destination. In this exemplary embodiment, object data composes at least any one of numerical data stored in the storage 330 and a software program in which specific processing (a process, a function and an algorithm) was written.

The object data placement device 2000 includes a hash calculation function 301 and a storage determination function 320, and can refer to a space designation information-storage relational table 305 and a characteristic quantity 306. Because the hash calculation function 301, the space designation information-storage relational table 305 and the characteristic quantity 306 can adopt the same configuration as the hash calculation function 101, the space designation information-storage relational table 105 and the characteristic quantity 106 in the first exemplary embodiment mentioned above, the overlapped description in this exemplary embodiment will be omitted.

The storage determination function 320 includes a space designation information calculation function 321 and a space direction determination function (determination function) 309. In this exemplary embodiment, the space designation information calculation function 321 outputs space designation information 315 like the space designation information calculation function 103 generating the space designation information 115 in the first exemplary embodiment. However, the space designation information calculation function 321 has a plurality of partial space designation information calculation functions 302 (A) and 306 (B), and outputs any one of space designation information 3021 and 3061 which these space designation information calculation functions output as the space designation information 115 in this exemplary embodiment (detailed description will be made later).

The space direction determination function 309 determines whether the space designation information 315 obtained from the space designation information calculation function 321 indicates the partial space DS included in the partial space-storage relational table 305 based on partial space information 314. And as a result of the determination, when the partial space DS which the space designation information 315 indicates exists in the partial space-storage relational table 305, the space direction determination function 309 outputs the storage identification information 317 detected in the partial space-storage relational table 305. As a result, the target object data is stored in the storage 330 corresponding to the storage identification information 317 among a plurality of storages 330. On the other hand, as a result of the determination, when the space designation information 315 indicates neither partial space DS, the space direction determination function 309 sends a re-calculation order 313 to the space designation information calculation function 321.

When the designated space DS which the space designation information calculation function 321 treats is changed, the space designation information 315 which the space designation information calculation function 321 outputs satisfies the following condition.

That is, the space designation information 315 which the space designation information calculation function 321 outputs after change of the designated space DS among each space designation information 315 which the space designation information calculation function 321 outputs before the designated space DS is changed, is included in the state that the order of each space designation information 315 which the space designation information calculation function 321 outputs is maintained after the change. The change of the designated space DS may be changed according to the directions by an external device or a user.

The space designation information calculation function 321 has a plurality of partial space designation information calculation functions in relation to this condition. That is, as shown in FIG. 10, in this exemplary embodiment, the space designation information calculation function 321 includes two sets, the space designation information calculation function (A) 302 and the space designation information calculation function (B) 306 as an example, and generates the space designation information 315 by using these.

In this exemplary embodiment, for example, according to issuing a write instruction to the storage 330 in an external device, the object data and its metadata 310 are inputted to the object data placement device 2000. The object data placement device 2000 should be a configuration which can obtain the metadata at least among the object data and its metadata 310.

The hash calculation function 301, by performing a hash operation based on the obtained metadata 310, outputs two hashes 311a and 311b. As the hash calculation, an operation which outputs the metadata 310 as it is, or an operation which outputs after processing can be adopted. Here, the hashes 311a and 311b are examples of information generated based on the metadata available for generation of space designation information 315 (any one of space designation information 3021 and 3061 in this exemplary embodiment). As this metadata, for example, an address, an object name, a directory name or a file name is assumed.

The space designation information calculation function (A) 302, by using the hash 311a as a seed (an initial value), generates the space designation information (A) 3021. On the other hand, the space designation information calculation function (B) 306, by using the hash 311b as a seed, generates the space designation information (B) 3061. However, the designated space DS of the space designation information calculation function (B) 306 includes the designated space DS of the space designation information calculation function (A) 303. The space designation information (A) 3021 which the space designation information calculation function (A) 302 generates and the space designation information (B) 361 which the space designation information calculation function (B) 306 generates have almost no correspondence relationship.

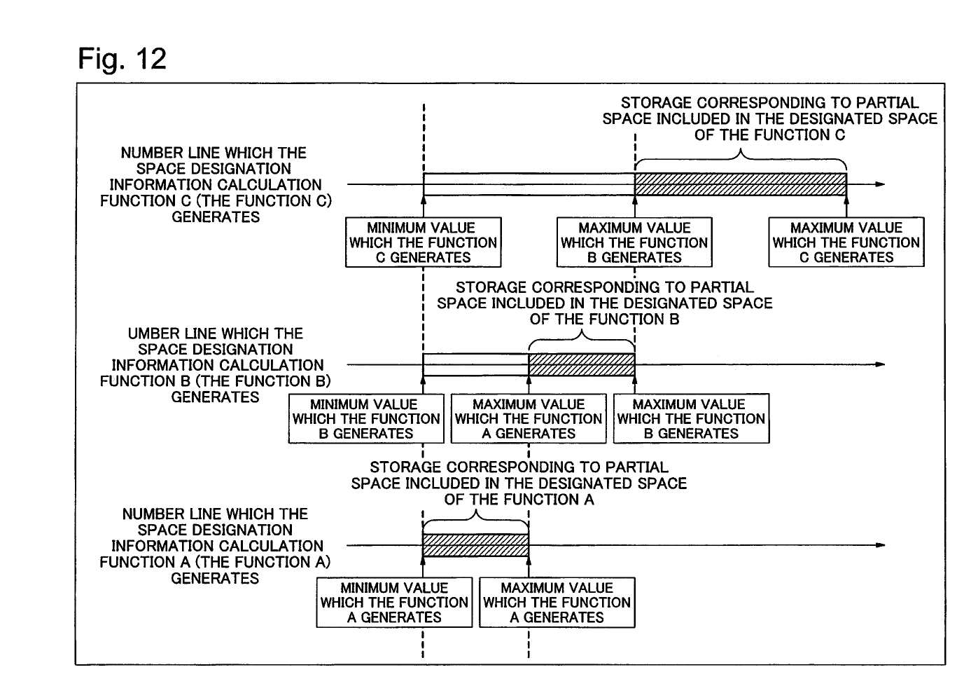

However, in the object data placement device 2000 according to this exemplary embodiment, a case where the designated space DS of the space designation information calculation function (B) 306 does not include the partial space DS registered in the partial space-storage relational table 305 is not considered. A device configuration in consideration of this point is described later with reference to FIG. 12.

The partial space-storage relational table 305 has the same configuration as the partial space-storage relational table 105 in the first exemplary embodiment mentioned above. Therefore, storage information registered in the partial space-storage relational table 305 does not need to correspond to a storage device in one to one like the case mentioned above in the first exemplary embodiment.

The storage determination function 320, when the partial space information (partial space DS) registered in the partial space-storage relational table 305 is included in the designated space of the space designation information calculation function (A) 302, determines whether or not the storage corresponding to the space designation information (A) 3021 as the space designation information 315 exists.

Here, it is defined about an expression of “judges (determines) whether or not the storage corresponding to the space designation information X exists” adopted in the following description. This expression represents: processing which determines whether there is a partial space PS which the space designation information X indicates in the partial space PS which is associated with the partial space-storage relational table 305 which should be referred to; and processing which determines that there is a storage 330 associated with the partial space PS which the space designation information X indicates when there is the partial space PS which the space designation information X indicates by the determination (it is similar in each exemplary embodiment below).

And the storage determination function 320, when determining that it does not exist, redoes generation of the space designation information (A) 3021 by the space designation information calculation function (A) 302. On the other hand, the storage determination function 320, when determining that it exists, outputs the storage identification information 317 as information which can distinguish the storage 330 corresponding to the partial space DS which the space designation information (A) 3021 indicates.

On the other hand, the storage determination function 320, when the partial space PS registered in the partial space-storage relational table 305 is not included in the designated space DS which the space designation information calculation function (A) 302 treats, generates the space designation information (B) 3061 by the space designation information calculation function (B) 306.

And the storage determination function 320 compares the designated space DS which the space designation information calculation function (A) 302 treats and the space designation information (B) 3021 as the space designation information 315. As a result of this comparison, when the space designation information (B) 3021 is not included in the designated space of the space designation information calculation function (A) 302, the storage determination function 320 determines whether the storage 330 corresponding to the space designation information (B) 3021 exists. And when determining that it does not exist, the storage determination function 320 redoes from generation of space designation information (B) 3061 by the space designation information calculation function (B) 306. On the other hand, when determining that it exists, the storage determination function 320 outputs the storage identification information 317 as information which can distinguish the storage 330 corresponding to the partial space DS which the space designation information (B) 3061 indicates.

And as a case remaining, a case where the space designation information (B) 3061 is included in the designated space DS of the space designation information calculation function (A) 302 is considered. In this case, the space designation information calculation function (A) 302 generates the space designation information (A) 3021, and the storage determination function 320 determines whether the storage 330 corresponding to the partial space PS which the space designation information (A) 3021 indicates exists. And when determining that it does not exist, the storage determination function 320 redoes from generation of space designation information (B) 3061 by the space designation information calculation function (B) 306. On the other hand, when determining that it exists, the storage determination function 320 outputs the storage information 317 as information which can distinguish the storage 330 corresponding to the partial space DS which the space designation information (A) 3021 indicates.

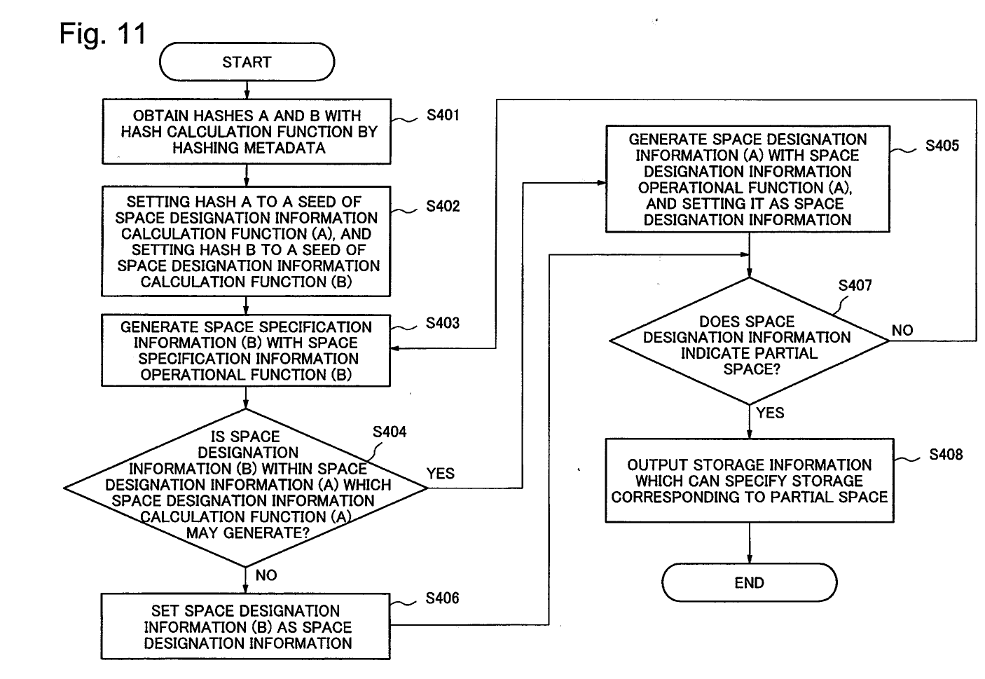

Next, placement processing of object data which the object data placement device 2000 performs in order to realize a series of operation relating to this exemplary embodiment mentioned above, is explained with reference to FIG. 11. Processing explained below premises that the partial space PS registered in the partial space-storage relational table 305 is not included in the designated space DS of the space designation information calculation function (A) 302 and is included in the designated space DS of the space designation information calculation function (B) 306.

FIG. 11 is a flow chart showing placement processing of object data which the object data placement device according to the second exemplary embodiment of the present invention performs. When the object data placement device 2000 is realized by a computer, a CPU (Central Processing Unit) of the computer will execute processing of each step explained below (detailed description will be made later with reference to FIG. 17).

Step S401: The hash calculation function 301, by performing a hash operation based on the metadata among the target object data and its metadata 310, obtains a hash (A) 311a and a hash (B) 311b. And the hash calculation function 301 gives the hash (A) 311a to the space designation information calculation function (A) 302 and gives the hash (B) 311b to the space designation information calculation function (B) 306.

Step S402: The space designation information calculation function (A) 302 sets the obtained hash (A) 311a to a seed (an initial value), and the space designation information calculation function (B) 306 sets the obtained hash (B) 311b to a seed (an initial value).

Step S403: The space designation information calculation function (B) 306 generates the space designation information (B) 3061.

Step S404: The space direction determination function 309 determines whether the space designation information (B) 3061 obtained at Step S403 is included in the designated space DS of the space designation information calculation function (A) 302. As a result of this determination, when the space designation information (B) 315 is included in the designated space of the space designation information calculation function (A) 302 (YES at Step S404), the space direction determination function 309 gives the re-calculation order 313 to the space designation information calculation function 321 and advances processing to Step S405. On the other hand, when the space designation information (B) 315 is not included in the designated space of the space designation information calculation function (A) 302 (NO at Step S404), the space direction determination function 309 advances processing to Step S406.

Step S405: The space designation information calculation function (A) 302 generates the space designation information (A) 3021. At that time, the space designation information calculation function 321 gives the generated space designation information (A) 3021 to the space direction determination function 309 as space designation information 315 and advances processing to Step S407.

Step S406: The space designation information calculation function 321, according to the result of determination in Step S404, gives the space designation information (B) 3061 to the space direction determination function 309 as space designation information 315 and advances processing to Step S407.

Step S407: The space direction determination function 309 determines whether the space designation information 315 (that is, any one of space designation information 3021 and 3061) indicates the partial space PS which is registered in the partial space-storage relational table 305. The space direction determination function 309, when determining that it indicates it (YES at Step S407), advances processing to Step S408, and returns processing to Step S403 when determining that it does not indicate (NO at Step S407).

Step S408: The space direction determination function 309 outputs the storage identification information 317 as information which can specify the storage 330 corresponding to the partial space PS which the space designation information 315 indicates.

In this exemplary embodiment mentioned above, a case where the different hashes 311a and 311b were adopted to two space designation information calculation functions 302 and 306 was explained. However, when the space designation information calculation function (A) 302 and the space designation information calculation function (B) 306 output space designation information that have almost no correspondence relationship when the same hash is inputted, the same hash value may be inputted to these two space designation information calculation functions 302 and 306.

### Modification of Second Exemplary Embodiment

By the way, in the placement processing of object data explained with reference to FIG. 10 and FIG. 11, it is based on the assumption that all partial spaces PS registered in the partial space-storage relational table 305 as partial space PS were included in the designated space DS of the space designation information calculation function (B) 306. Accordingly, in the modification explained below, a device configuration (processing configuration) which is not constrained by such the assumption (precondition) is explained with reference to FIG. 12.

That is, in this modification, when the partial space PS registered in the partial space-storage relational table 305 was no longer included in the designated space DS of the space designation information calculation function (B) 306, a third space designation information calculation function (space designation information calculation function C) is further added to the object data placement device 2000 (storage determination function 320). In this case, the designated space DS of the space designation information calculation function C includes the partial space PS registered in the partial space-storage relational table 305.

FIG. 12 is a diagram explaining operations of three space designation information calculation functions according to a modification of the second exemplary embodiment. Here, the partial space PS registered in the partial space-storage relational table 305 is explained about an example of the case where it is a number line that is a one-dimensional space for convenience of explanation. In this case, it is assumed that space designation information 315 is expressed by one real number which is one point on the number line.

A horizontal axis shown in FIG. 12 expresses space designation information (the real number) which three space designation information calculation functions (A, B, and C) generate with a number line. A belt-like range indicated on the each horizontal axis represents a range of space designation information (the real number) which can be generated by the each space designation information calculation function. Here, the range is the range of the value from a certain value to the other value. And the range that attached a slanted line in the each belt-like range represents the range where the real number that the corresponding space designation information calculation function generates is adopted at the time of determining the storage.

The object data placement device according to this modification is provided with three space designation information calculation functions having the generation ranges of the space designation information as shown in FIG. 12. And these three space designation information calculation functions operate as follows.

(1) When the zero- or more-dimensional space which space designation information which the space designation information calculation function (C) generates indicates is not included in the designated space DS of the space designation information calculation function (B), it is determined whether or not there is a corresponding storage by using the space designation information which the space designation information calculation function (C) generated.

(2) When the zero- or more-dimensional space which space designation information which the space designation information calculation function (C) generates indicates is included in the designated space DS of the space designation information calculation function (B), space designation information is generated by the space designation information calculation function (B).

(3) When the zero- or more-dimensional space which space designation information which the space designation information calculation function (B) generates indicates is not included in the designated space DS of the space designation information calculation function (A), it is determined whether or not there is a corresponding storage by using the space designation information which the space designation information calculation function (B) generated.

(4) when the zero- or more-dimensional space which space designation information which the space designation information calculation function (B) generates indicates is included in the designated space DS of the space designation information calculation function (A), space designation information is generated by the space designation information calculation function (A), and it is determined whether or not there is a corresponding storage by using the space designation information which the space designation information calculation function (A) generated.

Next, placement processing of object data when using the three space designation information calculation functions mentioned above, is explained, comparing with the flow chart shown in FIG. 11.

The space designation information calculation function (C) sets a hash for the space designation information calculation function (C) to a seed (an initial value). This processing corresponds to Step S402. And the space designation information calculation function (C) generates the space designation information (C) and gives the generated space designation information (C) to the space direction determination function 309. This processing corresponds to Step S403.

When the storage 330 is determined, the space direction determination function 309, when the space designation information (C) is not included in the designated space DS of the space designation information calculation function (B) 306, determines whether the partial space PS which the space designation information (C) indicates exists. When being determined that the partial space PS does not exist by this determination, processing is returned to the generation of the space designation information (C) by the space designation information calculation function (C). This processing corresponds to Step S407 and Step S403 after that.

On the other hand, when being determined that the partial space PS exists by the determination, the storage determination function 320 outputs the storage identification information (the storage ID) 317 corresponding to the partial space PS which the space designation information (C) indicates. This processing corresponds to Step S407 and Step S408.

When the space designation information (C) is included in the designated space DS of the space designation information calculation function (B) 306, the space designation information calculation function (B) 306 generates space designation information (B), and determines whether or not this space designation information (B) is included in the designated space DS of the space designation information calculation function (A) 302. This processing corresponds to Step S405 and Step S407 after that.

And when the space designation information (B) as the space designation information 315 is not included in a designated space of the space designation information calculation function (A) 302, the storage determination function 320 (space direction determination function 309) determines whether the partial space PS which the space designation information (B) indicates exists. This processing corresponds to Step S406 and Step S407. When being determined that the partial space PS does not exist by this determination, processing is returned to the generation of space designation information (C) by the space designation information calculation function (C). This processing corresponds to Step S407 and Step S403 after that.

On the other hand, when being determined that the partial space PS exists by the determination, the storage determination function 320 outputs the storage identification information (the storage ID) 317 corresponding to the partial space PS which the space designation information (B) indicates. This processing corresponds to Step S407 and Step S408.

When the space designation information (B) is included in the designated space of the space designation information calculation function (A) 302, the space designation information calculation function (A) 302 generates the space designation information (A) 312, and determines whether or not the partial space which the space designation information (A) indicates exists. This processing corresponds to Step S405 and Step S407 after that. When being determined that the partial space does not exist by this determination, processing is returned to the generation of the space designation information (C) by the space designation information calculation function (C). This processing corresponds to Step S407 and Step S408.

On the other hand, when being determined that the partial space exists by the determination, the storage determination function 320 outputs the storage information (the storage ID) 317 corresponding to the partial space which the space designation information (A) indicates. This processing corresponds to Step S407 and Step S408.

The processing configuration according to this modification is generalized and explained hereinafter. In this case, the object data placement device has a plurality of space designation information calculation functions whose designated spaces DS are different each other. In the plurality of space designation information calculation functions, there is a relation that the designated space DS of the space designation information calculation function with the range number n (however, n is a natural number) is included in the designated space DS of the space designation information calculation function with the range number (n+1). All space designation information calculation functions, by inputting different hashes, output space designation information that has almost no correspondence relationship.

And in the case of the above-mentioned device configuration, the space direction determination function (309) performs:

(I) setting the biggest range number as p, and setting the big range number to the next as q;

(II) comparing the space designation information and the partial space PS (partial space registered in the partial space-storage relational table (305)) when the space designation information generated by the space designation information calculation function with the range number p is not included in the designated space DS of the space designation information calculation function with the range number q, and determining the storage 330 corresponding to the storage identification information (storage ID) 317 associated with the partial space to be the placement destination of the target object data when the space designation information indicates the partial space PS while generating space designation information and redoing from the above (I) when it does not indicate the partial space PS; and

(III) subtracting one from p and subtracting one from q when the space designation information generated by the space designation information calculation function with the range number p is included in the designated space DS of the space designation information calculation function with the range number q, and as a result of the subtraction, repeating the above (II) when q is not zero, while comparing space designation information generated by the space designation information calculation function with the range number 1, and the partial space PS when q is zero, and determining the storage 330 corresponding to the storage identification information (storage ID) 317 associated with the partial space to be the placement destination for the target object data when the space designation information indicates the partial space PS, while generating space designation information and redoing from the above (I) when it does not coincide.

At that time, preferably, the designated space DS of the space designation information calculation function with the biggest range number includes the subspace PS.

As understood from this modification mentioned above, when there is a partial space which is not included in the designated spaces DS of a plurality of space designation information calculation functions in the partial space PS registered in the partial space-storage relational table, a space designation information calculation function in which the designated space DS includes partial spaces registered with all partial space-storage relational tables 305 should be provided newly like aforementioned configuration.

According to such second exemplary embodiment and its modification, like the first exemplary embodiment mentioned above, even when the storages 330 which store object data increase or decrease, the state of storing object data of the number corresponding to an approximate balance (ratio) set to the each storage can be maintained by a small operation amount and the minimum movement of object data. According to the second exemplary embodiment and its modification, a balance (ratio) in the number of the object data placed in the each storage can be set relatively easily.

Accordingly, compared with technology disclosed in non-patent literatures 1 and 2 and patent literatures 1 and 2 explained as the related art, the method according to the second exemplary embodiment and its modification can set an approximate ratio of the number of object data placed in the each storage relatively flexibly. According to this exemplary embodiment, it becomes possible to make scalability and efficiency compatible satisfactorily compared with the method disclosed in patent literature 3. Therefore, for example, in a system to realize a distributed storage by combining a plurality of storages where storage capacities are different, according to this exemplary embodiment and its modification, each object data can be placed easily, and without generation of wasteful consumption in a storage area in the each storage.

Moreover, according to this exemplary embodiment and its modification, a realistic and efficient object data placement device can be realized without being constrained by the assumed conditions (that is, the designated space SD with which the space designation information calculation function (103) deals includes the partial space registered in the partial space-storage relational table (105)) in the first exemplary embodiment.

That is, in the first exemplary embodiment, when the designated space DS which the space designation information calculation function 103 treats is set too much more widely than the range that partial space PS included in the partial space-storage relational table 105 occupies, a possibility that the space direction determination function 104 determines that the correspondence storage does not exist in the space designation information 115 generated by the space designation information calculation function 103 becomes high. In this case, because computing time becomes long, the device configuration (processing configuration) which sets the designated space DS which the single space designation information calculation function (103) treats too much widely is not desirable.

In contrast, according to the second exemplary embodiment and its modification mentioned above, by using a plurality of space designation information calculation functions in which designated spaces DS treated are different, even when the range that partial space PS used in the partial space-storage relational table 305 occupies may become wide, reduction of computing time can be realized.

In each exemplary embodiment and its modification mentioned above, although it is desirable to place only a quantity of object data nearly corresponding to a balance (ratio) specified for every placement destination that a size of object data treated as one data is uniform, but not limited to this.

When object data is taken apart by the treating unit, a mode that the metadata is hashed and the seed for the space designation information calculation function is generated by the hash for every treating unit of the object data based on the hashed result may be adopted. And a mode that the seed for the space designation information calculation function is generated by hashing the metadata and the identifier that identifies each treating unit for every treating unit of the object data may be adopted.

In each exemplary embodiment and its modification mentioned above, there is a case where one object data would like to be multiplexed and stored. In this case, a mode that a function which specifies the storage (116, 330) in only a quantity specified from the outside is provided in the object data placement device (100, 2000), and the same object data is placed in the plurality of specified storages can be adopted. In this case, from the reason for representing a difference in the storage capacity of the each storage to be used, there is a possibility that a plurality of partial spaces PS corresponds to one storage in the partial space-storage relational table (105, 305). Therefore, when needed to store by different storages, it should be confirmed that a plurality of space designation information indicates the partial spaces corresponding to the different storages with the storage determination function (102, 320) by using a table or an algorithm for determining the partial space PS corresponding to the single storage.

As further modification similar to the aforementioned constitution, there is a case that the data protection would like to be performed according to RAID 5 between different storages, for example. Accordingly, in this modification, a function to specify a plurality of storages may be provided in the object data placement device (100, 2000) in order to store a plurality of related object data in a plurality of storages reciprocally different, and the plurality of related object data may be placed in the plurality of the specified storages. In that case, from the reason for representing a difference in the storage capacity of the each storage to be used, there is a possibility that a plurality of partial spaces PS corresponds to one storage in the partial space-storage relational table (105, 305). Therefore, when needed to store by different storages, a table or an algorithm for determining the partial space PS corresponding to the single storage may be used. And in this case, it should be confirmed that the partial space PS which the space designation information generated by the storage determination function (102, 320) indicates to the related object data is the partial space corresponding to the different storage. According to such mode, by restricting combination of partial spaces PS which the space designation information (115, 315) generated by the storage determination function (102, 320) indicates, a plurality of related object data can be distributionally placed in the different storages.

In each exemplary embodiment and modification mentioned above, the space designation information calculation function repeats generation of space designation information until the space designation information (115 or 315) which indicates the partial space PS corresponding to the storage (116, 330) as a placement destination is obtained. Therefore, in some case, there is a possibility of taking time to determine the storage to which object data should be placed. Accordingly, in order to avoid such situation, when space designation information which indicates a partial space corresponding to the storage cannot be obtained even if space designation information is generated only for the predetermined number of times, a mode that any one is selected from the partial spaces PS with the corresponding storages with a random number may be adopted.

As further modification, when the storage (116, 330) is determined, a table where metadata and a storage are associated may be used. In this case, first, when the storage can be determined by referring to the table, the corresponding storage is determined. And when the storage cannot be determined by referring to the table, the storage should be determined by the placement processing according to each exemplary embodiment mentioned above. According to such state, a device configuration that for example, while the object data that would like to be accessed at high speed is placed in the storage which operates at high speed especially, the placement processing according to the each exemplary embodiment mentioned above is applied to the other object data can be realized.

Further as modification, when object data is stored in the storage (116, 330), it may be stored in the state of being divided into plural portions (partial object data). In that case, each partial object data itself does not have a specific identifier. Accordingly, in a case of such mode, the following processing may be added. That is, in the modification, it is considered a configuration that an identifier determined uniquely respectively is given to the each partial object data by calculating an identifier which the object data has by a calculation function of a hash. For example, a case that after an object data B with an identifier A is divided into three of partial object data (B1, B2, B3), it is stored in a storage is considered. In this case, simply for example, the specific identifier (sub information) of three of the partial object data may be given as follows, and their specific identifier may be adopted as the metadata in each exemplary embodiment mentioned above.

Partial file B1: Information added 0 to the identifier A,

Partial file B2: Information added 1 to the identifier A, and

Partial file B3: Information added 2 to the identifier A.

That is, in this modification, the hash calculation function (101, 301) generates specific sub information for the each partial object based on one of specific information (identifier A) provided in the object data B and generates a hash for each partial object based on the sub information. The storage determination function (102, 320) generates space designation information by using the hash generated for each of the partial objects and compares a partial space and the space designation information with reference to the partial space-storage relational table (105, 305). And when the space designation information indicates the partial space, the storage determination function (102,320) determines the storage corresponding to the storage identification information associated with the partial space as a placement destination of the partial object.

As further modification, a case where a plurality of spaces is used is considered. In this case, a partial space PS may exist in the respective spaces. In this case, when the space designation information (115, 315) is generated, the space should be specified based on the identifier of the object data and generated the space designation information corresponding to the designated space. Single or plural spaces which the space designation information indicates are selected based on the space designation information, and a partial space on the space can be used for determining a placement destination of the object data.

By the way, in each exemplary embodiment and its modification mentioned above, as a placement destination of the object data, the storage (116, 330) which stores data was assumed. And it was assumed that the object data composes at least one of numerical data and a software program in which specific processing (a process, a function, an algorithm) is written. However, the scope of the present invention explained by taking each embodiment and its modification as an example is not limited to the each exemplary embodiment and the modification. Specifically, for example, it is assumed that an object is processing (such as an instruction, a process, a function, a program code and an algorithm). And in this case, the placement destination of the object is an operation execution environment (processing execution environment) such as a processor or an IP core (Intellectual Property Core) with which the processing is executed.

When applying the present invention that was explained by taking the each exemplary embodiment and its modification mentioned above as the application example to an execution environment which is a placement destination, for example, processing efficiency such as the load distribution (load balancing) between plural servers can be improved.

Moreover, the present invention is applicable to a case where it is an article such as a baggage as an object existing physically, as is evident from a third exemplary embodiment described below.

### Third Exemplary Embodiment

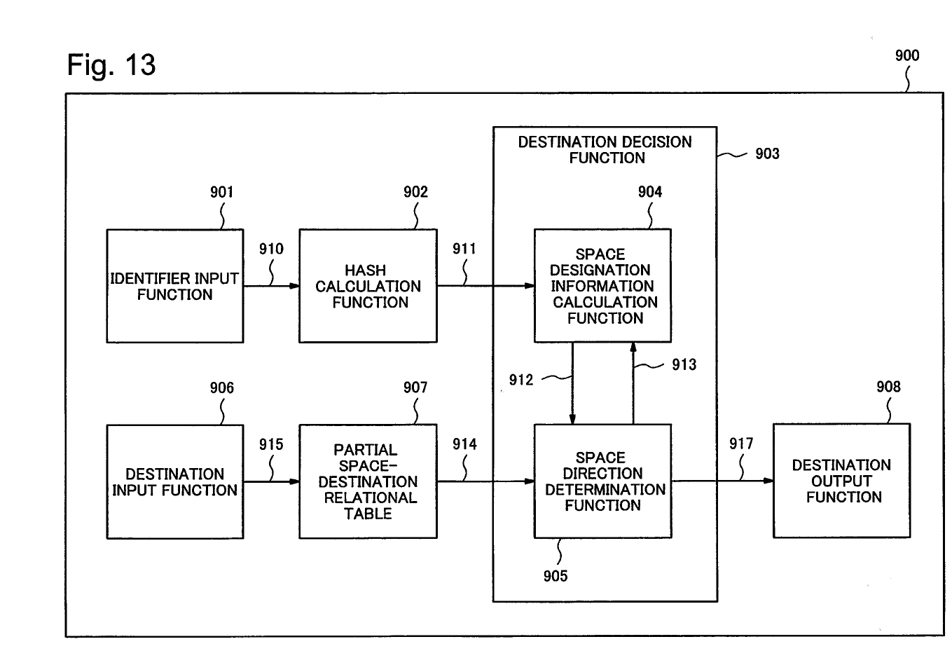

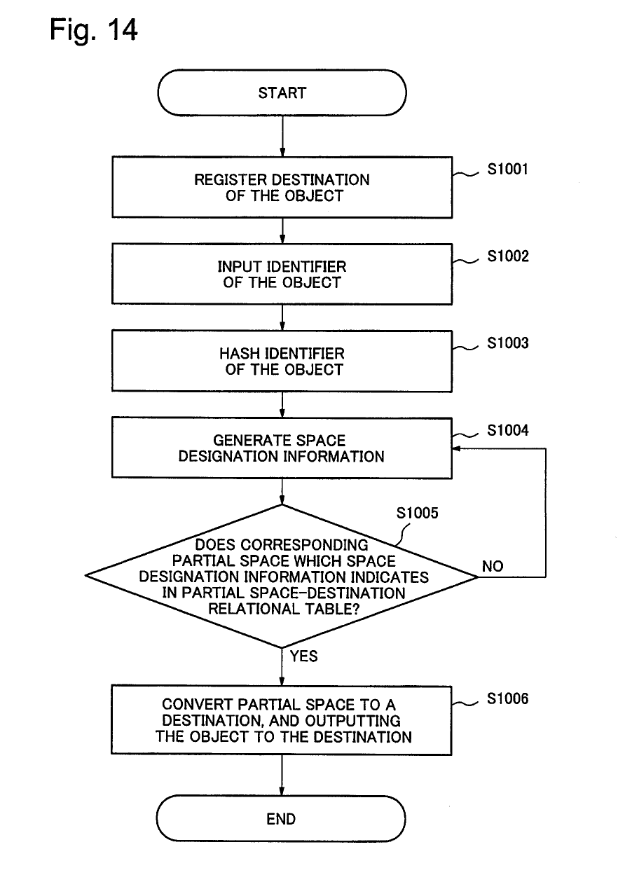

Hereinafter, a third exemplary embodiment of the present invention is explained with reference to FIGS. 13 and 14.

FIG. 13 is a block diagram showing a configuration of an object destination determination device according to a third exemplary embodiment of the present invention.

In this exemplary embodiment, according to inputting the identifier of an object (an article such as a baggage) which should be determined a destination (an address), an object destination determination device 900 (hereinafter, it may be abbreviated to “device 900”) determines the destination of the object.

The device 900 outputs the same destination to the same identifier in the state that the same destination is registered. The device 900 determines a destination of each object by a probability corresponding approximately to the ratio (degree, balance) specified in advance for every destination about all destinations.

When a destination is added or a destination is deleted, the device 900 maintains the characteristic to determine a destination for each object by the probability corresponding approximately to the pre-specified ratio (degree, balance) for every destination about all the destinations including the added destination or all the destinations except for the deleted destination.

According to such device 900, even when the destination has to be changed according to the addition or deletion of the destination, generation of objects to be changed the destinations can be kept to a minimum.

Hereinafter, the object destination determination device 900 is explained in detail. The device 900, in a broad sense, includes an identifier input function 901, a hash calculation function 902, a destination determination function 903, a destination input function 906, a partial space-destination relational table 907 and a destination output function 908. The destination determination function 903 includes a space designation information calculation function 904 and a space direction determination function 905.

The identifier input function 901 is able to obtain an identifier for identifying an object from outside. The identifier input function 901 provides an acquired identifier to the hash calculation function 902 as an identifier 910. Here, the identifier 910 is object-specific information. As the identifier input function 901, a user interface (man-machine interface) such as a keyboard and a mouse, or an image processing device which analyzes an input image representing such as a barcode, a zip code or dispatch number is assumed. And the identifier input function 901 may be a communication interface which acquires an identifier from an external device via a signal line.

When the same destination is set as a destination capable of sending an object, the device 900 determines the same destination according to inputting the same identifier. Therefore, when needed to get a different destination, a different identifier needs to be set to the device 900.

The hash calculation function 902 outputs a hash 911 by carrying out a hash operation based on the identifier 910. For the hash operation, an operation of outputting the identifier 910 as it is, or an operation of outputting after processing is employable. Here, the hash 911 is an example of space designation information generated based on information (identifier 910) specific to the object.

The destination determination function 903 as a placement destination determination function outputs destination information 917 of an object based on the hash 911 obtained from the hash calculation function 902 and partial space information 914 obtained from the partial space-destination relational table 907.

The space designation information calculation function 904 generates space designation information by using the hash 911 as a seed (an initial value). The space designation information calculation function 904 sends the generated space designation information as space designation information 912 to the space direction determination function 905. Here, as an algorithm which should be adopted for the space designation information calculation function 904 to generate space designation information, if it is an algorithm which generates space designation information with the low correlativity when a different seed is inputted, and generates the same space designation information when the seed is the same, an arbitrary algorithm is employable. However, as described above in the first exemplary embodiment, an algorithm with which space designation information indicates a part of the space WS by an approximately uniform distribution probability is desirable.

The space direction determination function 905 determines whether the partial space PS which the space designation information 912 indicates exists in the partial space-destination relational table 907 based on the space designation information 912 obtained from the space designation information calculation function 904 and the partial space information 914 obtained from the partial space-destination relational table 907. As a result of this determination, when the partial space PS which the space designation information 912 indicates exists, the space direction determination function 905 outputs a destination corresponding to the partial space PS as destination information 917 representing a destination of a target object. On the other hand, the space direction determination function 905 orders to generate next space designation information 912 by issuing a re-calculation order 913 to the space designation information calculation function 904 when the partial space PS which the space designation information 912 indicates does not exist.

According to acquiring destination information, a destination addition instruction and a destination delete instruction from outside, the destination input function 906 sends those information and instructions to the partial space-destination relational table 907 as a destination change instruction 915. As the destination input function 906, for example, a user interface (a man-machine interface) such as a keyboard and a mouse, and a communication interface which acquires information and an order from an external device via a signal line are assumed.

The partial space PS and the destination information (the destination identifier) corresponding to the partial space are associated and registered in the partial space-destination relational table 907. The same data structure as the partial space-storage relational table (FIG. 3A and FIG. 3B) in the first exemplary embodiment can be adopted as the partial space-destination relational table 907.

The partial space-destination relational table 907 is set up or updated from the outside of the device 900 in a suitable timing (the device 900 may generate itself).

That is, by the destination change instruction 915, the destination addition instruction may be sent from the destination input function 906. In this case, destination information representing a destination to add is included in the destination change instruction 915. The corresponding partial space is assigned newly to the partial space-destination relational table 907, and the partial space and the destination information included in the destination change instruction 915 are associated and registered therein.

Or, by the destination change instruction 915, the destination delete instruction may be sent from the destination input function 906. In this case, destination information representing a destination which should be deleted is included in the destination change instruction 915. And the destination information which is identical with the destination information included in the delete instruction and the partial space PS corresponding to that are deleted from the partial space-destination relational table 907. Further, when an addition instruction for a destination is sent newly, the partial space PS that deleted the correspondence with the destination may be reused as the partial space PS corresponding to the destination included in the addition instruction.

Or, by the destination change instruction 915, a change instruction for a destination may be sent from the destination input function 906. In this case, the destination information representing a destination before change and the destination information representing a destination after change are included in the destination change instruction 915. And the destination registered in the partial space-destination relational table 907 is changed by using the destination information before and after change included in the destination change instruction. Further, destination information does not need to correspond a destination in one-to-one. That is, identical destination information may be associated with the partial space-destination relational table 907 to a plurality of partial spaces. Or, the identical partial space may indicate a plurality of destinations as a group.

The destination output function 908 outputs a destination of an object to a target (target device) using the device 900. A mode of the destination output function 908 depends on a target using the device 900.

Next, processing of the object destination determination device 900 according to this exemplary embodiment is explained.

FIG. 14 is a flow chart showing destination determination processing of an object which the object destination determination device according to the third exemplary embodiment of the present invention performs. When the device 900 is realized by a computer, a CPU (Central Processing Unit) of the computer will execute processing of each step described below (detail will be described later with reference to FIG. 17).

Step S1001: First, as preliminary preparations, the destination input function 906 receives information on a destination and sends the information to the partial space-destination relational table 907 as the destination change instruction 915. In the partial space-destination relational table 907, the partial space PS corresponding to each destination is given, and a corresponding relationship between the partial space and the destination information is recorded. The information on the destination to record needs to be the information that a target which receives an output of the device 900 can determine the destination of the object.

Step S1002: The identifier input function 901 obtains the identifier of the object which should determine a destination in response to determination processing of the destination being started, and sends the acquired identifier to the hash calculation function 902 as the identifier 910.

Step S1003: The hash calculation function 902 gets the hash 911 by hash calculation based on the identifier 910. As an operation by the hash calculation function 902, various operations such as outputting the identifier 910 as it is, or calculating with a hash function can be considered. The hash 911 is sent to the space designation information calculation function 904 and it becomes a seed (an initial value) for generation of space designation information.

Step S1004: The space designation information calculation function 904 generates the space designation information 912 by using the hash 911 as the seed.

Step S1005: The space direction determination function 905 determines whether the partial space PS which the space designation information 912 indicates exists, by referring to the partial space-destination relational table 907. When the partial space PS which the space designation information 912 indicates does not exist, the processing is returned to Step S1004. In this case, the space designation information calculation function 904 generates next space designation information (912).

Step S1006: When the partial space PS which the space designation information 912 indicates exists, the space direction determination function 905 sends the destination information acquired by referring to the partial space-destination relational table 907 as destination information 917 to the destination output function 908. The destination output function 908 outputs a destination of an object to a target using the device 900. The destination output function 908 depends on a target using the device 900.

Next, a storage destination determination system of a stock (baggage) using the object destination determination device 900 mentioned above is explained.

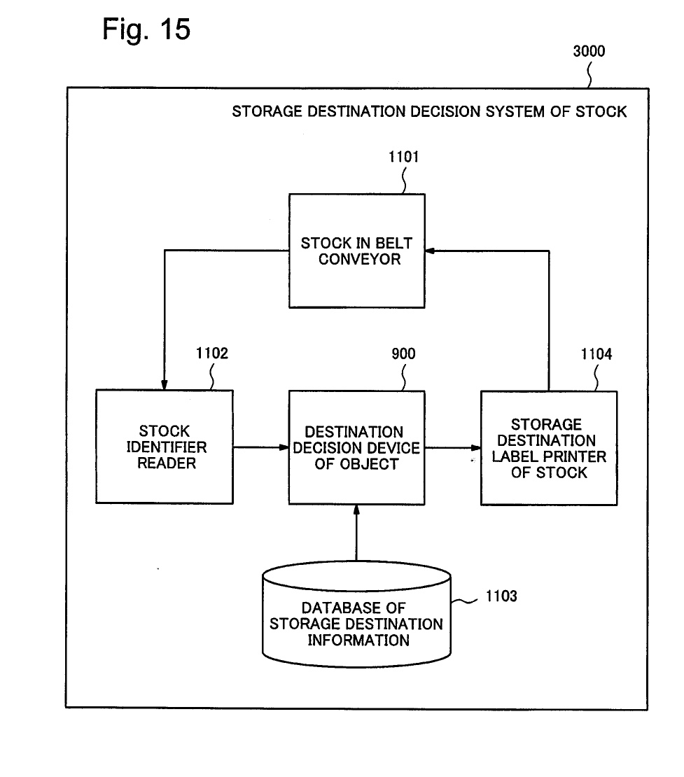

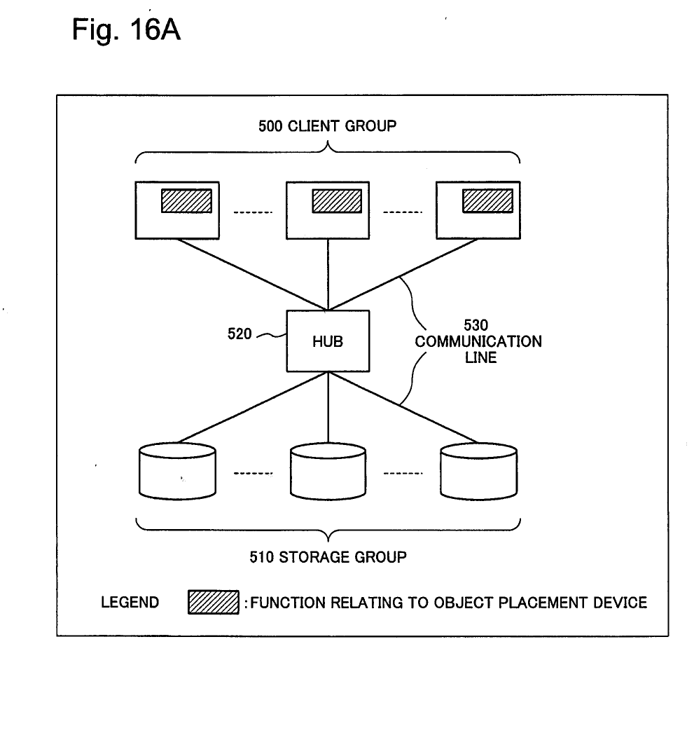

FIG. 15 is a block diagram showing a configuration of a storage destination determination system of a stock according to the third exemplary embodiment of the present invention. A storage destination determination system 3000 of a stock includes a stock 1101 in a belt conveyor, a stock identifier reader 1102, storage destination information database (DB) 1103, a storage destination label printer 1104 for a stock and an object destination determination device 900.

The stock identifier reader 1102 is a device which reads a specific identifier (a barcode, a zip code or a dispatch number) which was given to a stock (baggage) 1101 which flows in a belt conveyor by an optical scan and image processing. The stock identifier reader 1102 sets a read identifier to the device 900 (identifier input function 901). In the following description, the stock 1101 which becomes a processing object is called a target stock.

Information (storage destination information) representing a plurality of storage destinations with a possibility that s stock (baggage) which the storage destination determination system 3000 handles is stored in the storage destination information database (DB) 1103 in advance. By referring to the storage destination information database 1103, the device 900 (destination input function 906) acquires storage destination information (destination) corresponding to the identifier.

By a procedure mentioned above with reference to FIG. 14, the object destination determination device 900 (destination determination function 903) determines a storage destination (destination) of the target stock based on the identifier of the target stock and partial space information 914 obtained from the partial space-destination relational table 907. Here, the identifier of the target stock is information obtained from the stock identifier reader 1102. The partial space information 914 is information obtained from the partial space-destination relational table 907 updated by storage destination information from the storage destination information database 1103 appropriately.

The storage destination label printer 1104 is a device which prints a storage destination to the target stock which is the stock 1101 which flows in the belt conveyor according to the destination information (storage destination information) acquired from the device 900 (destination output function 908).

By the system configuration mentioned above, according to the storage destination determination system 3000, it is possible to determine a storage destination (destination) of the stock based on an identifier of a stock (target stock) which flows in the belt conveyor, and print a label representing a determined storage destination in the stock. In that case, according to a storage destination determination system 3000, when a plurality of stocks (objects) are placed in each storage destination (destination or placement destination), an approximate balance in a quantity of the stock which should be placed for every storage destination can be determined by relatively easy processing configuration, and when storage destinations increase or decrease, stocks that must be moved can be kept to a minimum.

### Fourth Exemplary Embodiment

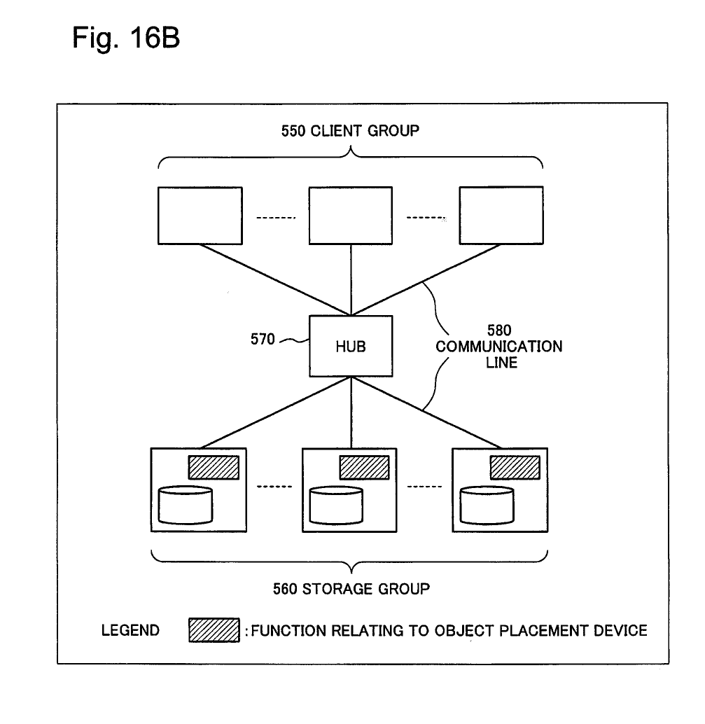

Next, the system environment (the hardware environment) that the object placement device (object destination determination device) mentioned above in the first to the third exemplary embodiments is carried out will be explained with reference to FIG. 16A and FIG. 16B.

As mentioned above, the device in each embodiment can be realized by a computer. In this case, the function of the device is realized by a CPU of a computer executing a software program. However, in the system environment that a plurality of storages (a storage group) is used, various variations are assumed at the place which sets up the function of the device.

FIGS. 16A and 16B are charts illustrating exemplarily a variation of a system environment according to the fourth exemplary embodiment of the present invention

In an example shown in FIG. 16A, a client group 500 including a plurality of clients and a storage group 510 including a plurality of storages are connected by a communication line 530 via a hub (HUB) 520. And in this example, the function of the object placement device (object destination determination device) is set up in a client group 500 as shown in FIG. 16A by a slanted line.

On the other hand, in an example shown in FIG. 16B, a client group 550 including a plurality of clients and a storage group 560 including a plurality of storages are connected by a communication line 580 via a hub (HUB) 570. And in this example, the function of the object placement device (object destination determination device) is set up in the storage group 560 as shown in FIG. 16B by a slanted line.

The storage groups 510 and 560 may be constituted by plural storages physically, plural virtual storages provided in a single storage, or their combination.

Thus, when realizing the object placement device (object destination determination device) described in the first to the third embodiments and their modifications, the environment carried out can be selected flexibly.

(Hardware Configuration)

And the each function that was shown in the drawing in the each embodiment mentioned above can be recognized to be a functional unit (software module) of the software program. An example of the hardware environment of this case will be described with reference to FIG. 17.

FIG. 17 is a chart illustrating exemplarily a hardware configuration of a client or a storage according to the first to the fourth exemplary embodiments and their modifications of the present invention. That is, FIG. 17 is a configuration of the computer which can realize a storage or a client shown in FIG. 16A and FIG. 16B and represents the hardware environment that the each function in the each embodiment described above can be realized.

The hardware shown in FIG. 17 includes a CPU 41, an ROM (Read Only Memory) 42, an RAM (Random Access Memory) 43 and a hard disk (storage device) 44, and these configuration is a general computer connected via a bus (communication line) 45. It is assumed a case that the hard disk 44 itself functions as a storage in the exemplary embodiment mentioned above, when the hardware is a storage.

And the present invention explained in the each embodiment mentioned above as an exemplary example can be realized by reading the computer program to the CPU 41 of the hardware concerned, and by executing it, after supplying the computer program, to the hardware shown in FIG. 17, which can realize the function of the block configuration drawings (FIG. 1, FIG. 2, FIG. 10, FIG. 13, FIG. 15) or the flow chart (FIG. 7, FIG. 11, FIG. 14) referred to in the explanation of the each embodiment. The computer program supplied in the device may be stored in a memory (42) as a temporary storage device or a nonvolatile storage device such as a hard disk device (44) which can be read and written.

In the case mentioned above, as the method of supplying the computer program in the hardware, a present general procedure such as a method of installing in the device via various recording media such as a CD-ROM, a method of downloading from the outside via communication lines such as the Internet, etc. are employable. And in such case, the present invention is configured by cords representing the computer program or a storage medium storing the computer program.

However, the object placement device (object destination determination device) mentioned above in the first to the third embodiments and their modifications may be realized by an exclusive hardware or a computer (computer system) which realizes execution environment dispersed physically or virtually.

### Example

Next, a specific example to which the object data placement device 2000 according to the second exemplary embodiment mentioned above can be applied is explained. In this example, hardware resources (the environment) of a computer which can realize the object data placement device will adopt the device configuration shown in FIG. 17 mentioned above.

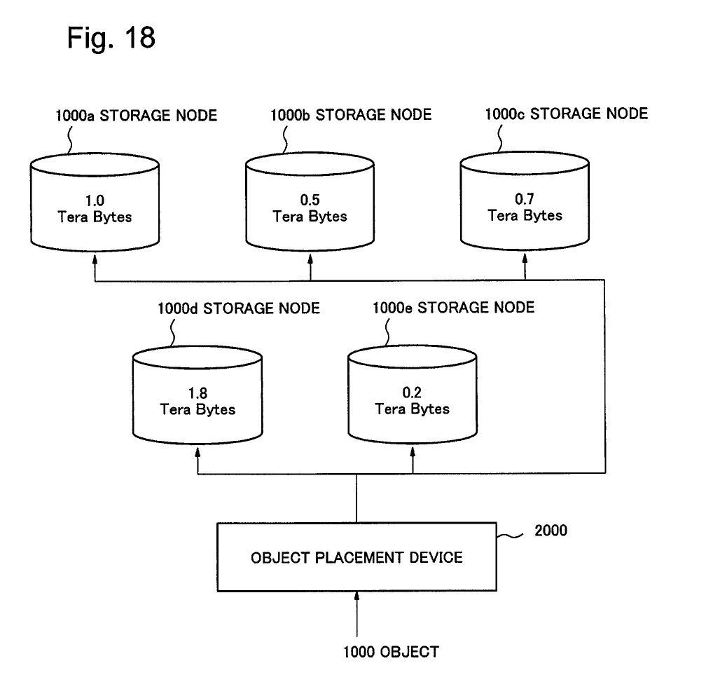

FIG. 18 is a diagram showing a configuration of a storage system as an example according to the second exemplary embodiment of the present invention. The storage system shown in FIG. 18 illustrates a configuration that five storage nodes (1000a to 1000e) are connected to the object data placement device 2000 in each exemplary embodiment mentioned above so that the object 1000 can be read and written. Here, these storage nodes (1000a to 1000e) are physical and separate elements, and they are distributionally placed on a communication network appropriately, for example. However, these storage nodes may be constituted virtually inside the hard disk 44, for example.

In this example, the storage nodes 1000a to 1000e will have the storage capacity (the maximum storage capacity) as shown in FIG. 18 and the following, for example. That is,

Storage node 1000a: 1.0 [Terabytes],

Storage node 1000b: 0.5 [Terabytes],

Storage node 1000c: 0.7 [Terabytes],

Storage node 1000d: 1.8 [Terabytes], and

Storage node 1000e: 0.2 [Terabytes].

In this example, as an example of the space WS, a continuous one-dimensional space is used. On this one-dimensional space, each position is expressed by a real number value.

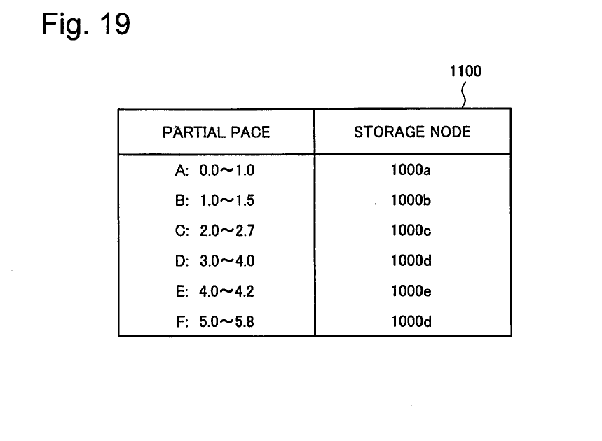

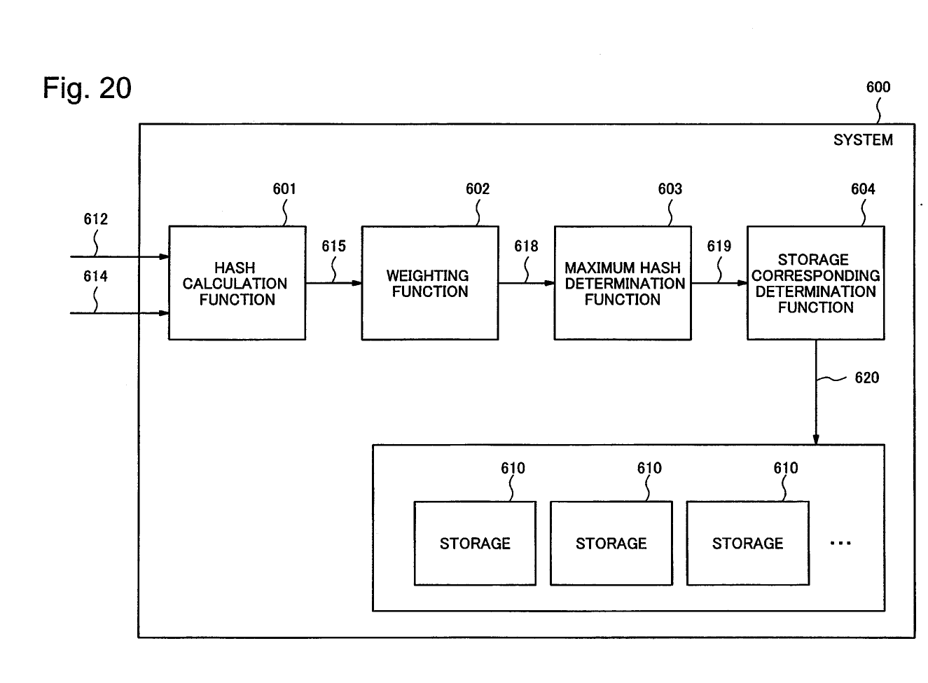

FIG. 19 is a chart showing a relational table (partial space-storage node relational table 1100) of a partial space and a storage node in the storage system as the example according to the second exemplary embodiment of the present invention.

That is, as shown in FIG. 18 and FIG. 19, the storage node 1000a corresponds to the partial space (PS) A of 1 (1 is not included) from 0 on the one-dimensional space. The storage node 1000b corresponds to the partial space (PS) B of 1.5 (1.5 is not included) from 1 on the one-dimensional space. The storage node 1000c corresponds to the partial space (PS) C of 2.7 (2.7 is not included) from 2 on the one-dimensional space. The storage node 1000d corresponds to the partial space (PS) D of 4 (4 is not included) from 3 on the one-dimensional space. And the storage node 1000d corresponds to the partial space (PS) D of 4 (4 is not included) from 3 on the one-dimensional space, and the partial space (PS) F of 5.8 (5.8 is not included) from 5 on the same space.

In this example, the space designation information calculation function 321 generates the real number from −1.0 to 8.0, and includes two space designation information calculation functions 302 and 306 (sub-space designation information calculation functions A and B).

The subspace designation information calculation function A (302) generates the real number from 0.0 to 4.0. The subspace designation information calculation function B (306) generates the real number from −1.0 to 8.0. That is, the designated space DS treated by the subspace designation information calculation function A is a space which the real number from 0.0 to 4.0 indicates. The designated space DS treated by the subspace designation information calculation function B is a space which the real number from −1.0 to 8.0 indicates. That is, in this example, the designated space DS treated by the subspace designation information calculation function B includes the designated space DS treated by the subspace designation information calculation function A. In other words about this, in this example, the designated space DS treated by the subspace designation information calculation function B is the widest, and the designated space DS treated by the subspace designation information calculation function A is a space having the next widest range (area) to the designated space DS treated by the subspace designation information calculation function B.

A case where object data A with identifier information “a” is inputted to the object data placement device 2000 is described.

First, the hash calculation function 301 adds a sentence string “A” or a sentence string “B” to the identifier information “a” about object data A, and calculates a hash. The hash calculated by adding the sentence string “A” is set as the hash A, and the hash calculated by adding the sentence string “B” is set as the hash B.

Next, the space designation information calculation function 321 generates the space designation information 315. As mentioned above with reference to FIG. 10, the space designation information calculation function 321 outputs the space designation information 315 which is the space designation information (subspace designation information) 3021 which the subspace designation information calculation function A (302) generates or the space designation information (subspace designation information) 3061 which the subspace designation information calculation function B (306) generates.

More specifically, in the space designation information calculation function 321, first, the subspace designation information 3061 is generated with the subspace designation information calculation function B having the widest designated space DS by using the hash B as a seed. Here, it is assumed that the generated subspace designation information is 3.0. In this case, the value that is 3.0 is included in the designated space DS (0.0-4.0) which the subspace designation information calculation function A treats. Therefore, the subspace designation information calculation function A employs the hash A as a seed and generates the subspace designation information 3021. Here, it is assumed that the generated subspace designation information is 1.7. In this example, because other subspace designation information calculation functions to treat a designated space DS smaller than the subspace designation information calculation function A do not exist, the subspace designation information 3021 that is 1.7 which the subspace designation information calculation function A generated is selected as the space designation information 315.

Next, the space direction determination function 309 determines whether or not a partial space DS which the space designation information 315 indicates exists. That is, the space direction determination function 309 refers to the partial space-storage node relational table 1100 (305) illustrated in FIG. 19 based on the space designation information 315 that is 1.7. As a result, the space direction determination function 309 recognizes that the partial space which the space designation information 315 that is 1.7 indicates does not exist. Therefore, by transmitting the re-calculation order 313 to the space designation information calculation function 321, the space direction determination function 309 directs to generate space designation information 315 newly.

Next, it is assumed that 6.2 was generated as the subspace designation information 3061 by the subspace designation information calculation function B in the space designation information calculation function 321 in response to the directions. In this case, subspace designation information 3061 that is 6.2 is not included in the designated space DS (0.0-4.0) which the subspace designation information calculation function A treats. Therefore, the subspace designation information 3061 that is 6.2 which the subspace designation information calculation function B generated is selected as the space designation information 315.

In this case, the space direction determination function 309 also recognizes that the space designation information indicates neither partial spaces with reference to the partial space-storage node relational table 1100 (305) in this case based on the space designation information 315 that is 6.2 like the procedure mentioned above in this case. Therefore, the space direction determination function 309 transmits the re-calculation order 313 to the space designation information calculation function 321.

And it is assumed that 2.9 were generated as the subspace designation information 3061 with the subspace designation information calculation function B in response to the directions in the space designation information calculation function 321. In this case, the subspace designation information 3061 that is 2.9 is included in the designated space DS (0.0-4.0) which the subspace designation information calculation function A treats. Therefore, it is assumed that a value whose subspace designation information 3021 is 0.4 is generated by the subspace designation information calculation function A. In this example, because the subspace designation information calculation function A treats the smallest designated space DS, the subspace designation information 3021 that is 0.4 which the subspace designation information calculation function A generated is selected as the space designation information 315.

In this case, the space direction determination function 309 also detects the storage node 1000a associated with the partial space A (0.0-1.0) with reference to the partial space-storage node relational table 1100 (305) based on the space designation information 315 that is 0.4 like the procedure mentioned above in this case. Therefore, the space direction determination function 309 outputs the storage identification information 317 corresponding to the storage node 1000a. That is, the object data placement device 2000 places the object data A in the storage node 1000a.

When the subspace designation information calculation functions A and B generate the subspace designation information (3021 and 3061) by an approximately uniform distribution probability, the space designation information 315 which the space designation information calculation function 321 outputs also becomes approximately uniform. That is, when the outputted space designation information 315 has an approximately uniform distribution probability, and the designated space DS which the space designation information calculation function 321 treats includes all partial spaces PS, a possibility that each placement destination (in this example, storage nodes 1000a to 1000e) is chosen as a placement destination of a certain object 1000 is approximately proportional to the area (the size) in the partial space PS corresponding to each placement destination.

Addition of Storage Node:

Here, in this example mentioned above, it is considered a case where a storage node 1000f with the storage capacity of 0.3 [Terabytes] is added to the object data placement device 2000 newly, and thereby, a storage node 100f is associated with the partial space-storage node relational table 1100 (305) newly as a partial space (PS) F of 6.3 (6.3 is not included) from 6 on the space WS.

In this case, by the addition of the partial space F corresponding to the storage node 1000f, a storage node storing each object data may be changed. Therefore, the object data placement device 2000 calculates a storage node storing those object nodes once again. A case when a storage node which should place the object data A with identifier information “a” is calculated is also considered here.

In this case, first, the hash calculation function 301 adds a sentence string “A” or a sentence string “B” to the identifier information “a” about the object data A and calculates a hash. The hash calculated by adding the sentence string “A” is set as the hash A, and the hash calculated by adding the sentence string “B” is set as the hash B.

Next, the space designation information calculation function 321 generates space designation information 315 by the same procedure as the example mentioned above.

That is, it is assumed that the subspace designation information 3061 which the subspace designation information calculation function B with the widest designated space DS generated is 3.0. In this case, although a new partial space F is added in the partial space-storage node relational table 1100, as a result, the space direction determination function 309 transmits a re-calculation order 313 to the space designation information calculation function 321 by a flow of the same processing as the case mentioned above. As a result, generation of new space designation information 315 is begun.

It is assumed that next, 6.2 is generated as subspace designation information 3061 in response to the directions with the subspace designation information calculation function B. In this case, because the value that is 6.2 is not included in the designated space DS (0.0-4.0) which the subspace designation information calculation function A treats like the example mentioned above, the subspace designation information 3061 that is 6.2 which the subspace designation information calculation function B generated is selected as the space designation information 315.

And the space direction determination function 309 refers to the partial space-storage node relational table 1100 to which the partial space F was added as mentioned above based on the space designation information 315 that is 6.2 obtained from the space designation information calculation function 321. As a result, the space direction determination function 309 detects the storage node 1000f which is associated with the partial space F (6.0-6.3) in which 6.2 is included. Therefore, the object data placement device 2000 moves the object data A to the storage node 1000f.

In the object data placement device 2000 according to this example, when a placement destination (storage node) is added, object data moves to only the added placement destination. In the object data placement device 2000, two partial space designation information calculation functions A and B provided in the space designation information calculation function 321 generate partial space designation information (3021 and 3061) having an approximately uniform distribution probability respectively. And when the designated space DS which these subspace designation information calculation functions treat includes all partial spaces PS, a possibility that each placement destination including the added placement destination is chosen has a characteristic approximately proportional to the area (the size) of the partial space corresponding to the each placement destination.

In order to maintain such characteristic when a placement destination (storage node) is added, it is required to provide subspace designation information calculation functions (A and B) which can generate the subspace designation information before the addition like the space designation information calculation function 321 mentioned above among partial spaces PS included in the partial space-storage node relational table 305 (1100) after the addition while the subspace designation information (3021 and 3061) generated before the addition maintain an order of the subspace designation information generated before the change.

Deletion of Storage Node:

Next, a case when a storage node 1000f was deleted from the object data placement device 2000 is considered. That is, in this case, according to the deletion of the partial space F, the partial space-storage node relational table 305 has returned to the state of the partial space-storage node relational table 1100 shown in FIG. 19. In this case, because a storage node storing each object data may be changed, the object data placement device 2000 calculates storage nodes storing those object nodes once again.

Here, a case where a storage node which places object data A with identifier information “a” is calculated is considered. The hash calculation function 301 generates the hash A and the hash B based on the identifier information “a” about the object data A like the case mentioned above.

Next, the space designation information calculation function 321 generates the space designation information 315 by the similar procedure in the example mentioned above. In this case, because the partial space-storage node relational table 305 has returned to the original state (FIG. 19) according to the deletion of the storage node 1000f, when the subspace designation information 3061 which the subspace designation information calculation function B generated are 3.0 and 6.2, respective results which the space direction determination function 309 outputs eventually becomes identical to the original case mentioned above respectively.

And in a case that a value which becomes 2.9 as subspace designation information 3061 is generated by the subspace designation information calculation function B when re-calculating space designation information 315, and when a value generated by the subspace designation information calculation function A as subspace designation information 3021 is 0.4, the value 0.4 is selected as the space designation information 315. As a result, in this case, like the procedure mentioned above, the space direction determination function 309 also detects the storage node 1000a associated with a partial space A (0.0-1.0) in this case based on the space designation information 315 with reference to the partial space-storage node relational table 1100 (305) returned to in the state shown in FIG. 19. Therefore, the space direction determination function 309 outputs the storage identification information 317 corresponding to the storage node 1000a. That is, the object data placement device 2000 moves object data A to a storage node 1000a according to the deletion of the storage node 1000f.

In the object data placement device 2000 according to this example, when a placement destination (storage node) is deleted, only object data which was placed in the deleted placement destination is moved. In the object data placement device 2000, two subspace designation information calculation functions A and B provided in the space designation information calculation function 321 generate the subspace designation information (3021 and 3061) having an approximately uniform distribution probability respectively. And when designated space DS which these subspace designation information calculation functions treat includes all partial spaces PS, a possibility that each remaining placement destination except for the deleted placement destination is chosen has a characteristic to be approximately proportional to an area (a size) of the partial space corresponding to the each placement destination.

In order to maintain such characteristic when a placement destination (storage node) is deleted, it is required that the subspace designation information calculation functions (A and B) which can generate the subspace designation information before the deletion are provided while the subspace designation information (3021 and 3061) generated before the deletion maintain the order of the subspace designation information generated before the deletion among partial spaces PS included in the partial space-storage node relational table 1100 (305) after the deletion like the space designation information calculation function 321 mentioned above.

The present invention has been described explained as each exemplary embodiment mentioned above, the modification thereof and an example applied to the example mentioned above. However, the technical scope of the present invention is not limited to the range that was indicated on in the each exemplary embodiment mentioned above. It is apparent to be able to add various changes or improvements for a person skilled in the art to the exemplary embodiments. In such case, the new exemplary embodiment that has added the change or improvement can also be included in the technical scope of the present invention. And this is obvious from the matter described in the claim.

That is, the present invention is not limited to the exemplary embodiments and the modification thereof mentioned above. In the scope of the present invention, the present invention is able to apply various modes which a person skilled in the art can understand.

This application is based upon and claims the benefit of priority from Japanese Patent Application No. 2012-052800, filed on Mar. 9, 2012, the disclosure of which is incorporated herein in its entirety by reference.

### REFERENCE SIGNS LIST

10 object placement device
11 identifier information.
12 relational information
14 placement destination
15 space designation information
16, 113, 313, 913 re-calculation order
17 placement destination designation information
22 space designation information generation function
24 placement destination determination function
41 CPU
42 ROM
43 RAM
44 hard disk (storage device)
45 bus (communication line)
100, 2000 object data placement device
101, 301, 601 hash calculation function
102, 320 storage determination function
103, 321 space designation information calculation function
104, 309, 905 space direction determination function
105, 305 partial space-storage relational table
106, 306 characteristic quantity
110, 310 object data and the metadata
111, 311a, 311b, 615, 911 hash (hash value)
114, 314, 914 partial space information
115, 315, 912 space designation information
116, 330, 610 storage.
117, 317 storage identification information.
301 hash calculation function
302 space designation information calculation function (partial space designation information calculation function) A
306 space designation information calculation function (partial space designation information calculation function) B
500, 550 client group
510, 560 storage group
520, 570 hub (HUB)
530, 580 communication line
600 system
602 weighting function
603 maximum hash determination function
604 storage corresponding determination function
612 object data metadata
614 storage metadata
618 hash with weight
619 maximum hash
620 storage identification information
900 object destination determination device
901 identifier input function
902 hash calculation function
903 destination determination function
904 space designation information calculation function
906 destination input function
907 partial space-destination relational table
908 destination output function
910 identifier
915 destination alteration command
917 destination information on object
1000 object.
1000a, 1000b, 1000c, 1000d, 1000e, 1000f storage node
1101 stock in belt conveyor
1102 stock identifier reader
1103 storage destination information database (DB)
1104 storage destination label printer of stock
1100 partial space-storage node relational table
3000 storage destination determination system of stock
3021, 3061 partial space designation information

1. An object placement device comprising:
a space designation information generation unit that generates space designation information, which indicates a multi-dimensional space allocated a partial space composing a part of a space which a self-device treats and have almost no correspondence relationship when mutually different identifier information are assigned, based on the identifier information generated on the basis of information specific to a target object to be placed in a placement destination; and
a placement destination determination unit that refers to relational information, which is associated with a placement destination identifier identifying the each placement destination capable of being placed an object and partial space information indicating the partial space, based on the space designation information, and determines, when being determined that the space designation information indicates partial space information included in the relational information, that the target object is placed in a placement destination corresponding to a specific placement destination identifier associated with the indicated specific partial space information in the relational information.

2. The object placement device according to claim 1, wherein the placement destination determination unit:
directs to generate new space designation information to the space designation information generation unit whenever determining that the space designation does not indicate partial space information included in the relational information, and
repeats to determine, based on the generated new space designation information, whether or not the new space designation information indicates the partial space information included in the relational information until a placement destination which the target object to be placed is determined.

3. The object placement device according to claim 1, wherein a number of dimensions in the multi-dimensional space is identical to at least the number of types of plural kinds of information representing the object.

4. The object placement device according to claim 1, wherein the space designation information generation unit limits, by referring to a characteristic quantity which composes a space axis and characterizes an attribute of the object, a range of a space in generating the space designation information.

5. The object placement device according to claim 1, wherein the space designation information generation unit limits, by referring to mutually different plural pseudo-random numbers which compose at least two space axes in the multi-dimensional space, a range of a space in generating the space designation information.

6. The object placement device according to claim 1, wherein the placement destination determination unit includes:
a space designation information generation unit that is capable of generating identical space designation information repeatedly in accordance with the identical information being inputted as the space designation information, and
a determination unit that determines, by referring to relational information, whether or not the space designation indicates the partial space information included in the relational information based on the space designation information generated by the space designation information generation unit, and for, when a specific partial space information indicating the space designation information is detected by the determination, determining so as to be placed the target object in a placement destination corresponding to a specific placement destination identifier associated with the specific partial space information in the relational information.

7. The object placement device according to claim 1, wherein
a space which can be indicated by the space designation information is able to be changed, and
space designation information generated by the space designation information generation unit after the change in each space designation information generated by the space designation information generation unit after the change maintains an order of the each space designation information generated by the space designation information generation unit before the change.

8. The object placement device according to claim 7, wherein:
the self-device includes the relational information, and
the placement destination determination unit changes the space by updating the partial space information associated with the relational information.

9. The object placement device according to claim 1, wherein a space which space designation information generated by the placement destination determination unit can indicate includes all the partial spaces.

10. The object placement device according to claim 9, wherein:
when the space designation information generation unit includes a plurality of subspace designation information generation unit, which generate mutually different subspace designation information capable of indicating a space,
in a plurality of the subspace designation information generation unit, when there is a relation that a first space which can be indicated by n-th subspace designation information generated by n-th subspace designation information generation unit is included in a second space which can be indicated by (n+1)-th subspace designation information, which is generated by (n+1)-th subspace designation information generation unit, capable of indicating the second space wider than the first space, and
the space designation information generation unit, in a process that the space designation information is sequentially generated from a subspace designation information generation unit generating the widest space in the plurality of subspace designation information generation unit, selects the generated subspace designation information as the space designation information when a generated subspace designation information is not included in a space which can be indicated by a subspace designation information, which is generated by a subspace designation information generation unit which should generate subspace designation information next, or when a subspace designation information generation unit which should generate subspace designation information next does not exist.

11. The object placement device according to claim 1, wherein the placement destination determination unit indicates a part of the space by an approximately uniform distribution probability for the space designation information.

12. The object placement device according to claim 1, wherein
the object is processing, and
the placement destination determination unit determines a placement destination where the processing is performed.

13. The object placement device according to claim 1, wherein
the placement destination is a storage, and
the object is object data which composes at least any one of numerical data stored in the storage and a software program described a specific processing.

14. The object placement device according to claim 1, wherein
the object is an article, and
the article is determined so as to be sorted to a placement destination determined by the placement destination determination unit.

15. An object placement method comprising:
generating space designation information, which indicates a multi-dimensional space allocated a partial space composing a part of a space which a self-device treats and have almost no correspondence relationship when mutually different identifier information are assigned, based on the identifier information generated on the basis of information specific to a target object to be placed in a placement destination;
referring to relational information, which is associated with a placement destination identifier identifying the each placement destination capable of being placed an object and partial space information indicating the partial space, based on the space designation information; and
determining, when being determined that the space designation information indicates partial space information included in the relational information, that the target object is placed in a placement destination corresponding to a specific placement destination identifier associated with the indicated specific partial space information in the relational information.

16. The object placement method according to claim 15, wherein
generating new space designation information whenever determining that the space designation does not indicate partial space information included in the relational information, and
repeating to determine, based on the generated new space designation information, whether or not the new space designation information indicates the partial space information included in the relational information until a placement destination which the target object to be placed is determined.

17. The object placement method according to claim 15, wherein a number of dimensions in the multi-dimensional space is identical to at least the number of types of plural kinds of information representing the object.

18. The object placement method according to claim 15, wherein
limiting, when generating the space designation information, by referring to a characteristic quantity which composes a space axis and characterizes an attribute of the object, a range of a space in generating the space designation information.

19. The object placement method according to claim 15, wherein
limiting, when generating the space designation information, by referring to mutually different plural pseudo-random numbers which compose at least two space axes in the multi-dimensional space, a range of a space in generating the space designation information.

20. The object placement method according to claim 15, wherein
enabling to change a space which the space designation information can indicate, and
maintaining, when the placement destination is determined, an order of the each space designation information generated after the change for space designation information generated after the change in the each space designation information generated before the change.

21. A non-transitory computer readable storage media storing a computer program for making a computer to execute:
a space designation information generation function that generates space designation information, which indicates a multi-dimensional space allocated a partial space composing a part of a space which the computer treats and have almost no correspondence relationship when mutually different identifier information are assigned, based on the identifier information generated on the basis of information specific to a target object to be placed in a placement destination; and
a placement destination determination function that refers to relational information, which is associated with a placement destination identifier identifying the each placement destination capable of being placed an object and partial space information indicating the partial space, based on the space designation information, and determines, when being determined that the space designation information indicates partial space information included in the relational information, that the target object is placed in a placement destination corresponding to a specific placement destination identifier associated with the indicated specific partial space information in the relational information.

22. The non-transitory computer readable storage media storing the computer program according to claim 21 for making the computer to execute processing as the placement destination determination function, the processing comprising:
generating new space designation information whenever determining that the space designation does not indicate partial space information included in the relational information, and
repeating to determine, based on the generated new space designation information, whether or not the new space designation information indicates the partial space information included in the relational information until a placement destination which the target object to be placed is determined.
